(19) United States
(12) Patent Application Publication
(10) Pub. No.: US 2018/0195329 A1
(43) Pub. Date: Jul. 12, 2018

(54) HINGES

(71) Applicant: BEDGEAR, LLC, Farmingdale, NY (US)

(72) Inventor: Eugene Alletto, Glen Head, NY (US)

(73) Assignee: BEDGEAR, LLC, Farmingdale, NY (US)

(21) Appl. No.: 15/852,250

(22) Filed: Dec. 22, 2017

Related U.S. Application Data
(60) Provisional application No. 62/467,422, filed on Mar. 6, 2017.
(60) Provisional application No. 62/443,260, filed on Jan. 6, 2017.

(51) Int. Cl. E05D 11/10; E05D 3/06; A47C 19/02

(52) U.S. Cl. CPC E05D 11/1021; E05D 3/06; A47C 19/12; E05D 2011/1092; A47C 19/021

(57) ABSTRACT

A hinge includes a first end plate, a second end plate and at least one inner plate positioned between the first end plate and the second end plate. The first end plate is connected to the at least one inner plate by a first pin that extends through the first end plate and the at least one inner plate. The second end plate is connected to the at least one inner plate by a second pin that extends through the first end plate and the at least one inner plate. The first end plate is rotatable relative to the at least one inner plate about a first pivot axis defined by the first pin. The second end plate is rotatable relative to the at least one inner plate about a second pivot axis defined by the second pivot pin.

### TECHNICAL FIELD

The present disclosure generally relates to hinges that are used to connect a first object to a second object such that the first object is movable relative to the second object.

### BACKGROUND

Components of conventional hinges typically pivot relative to one another about one axis to allow a limited angle of rotation between two objects that the hinge connects. However, it is typically impossible to adjust the angle between the components of the along the length of the hinge, thus limiting the amount of “bend” provided by the hinge. This disclosure describes an improvement over these prior art technologies.

### SUMMARY

In one embodiment, in accordance with the principles of the present disclosure, a hinge is provided that includes a plurality of plates that are connected to one another. The plates are interlocked like vertebrae in a spine. In particular, one end plate of the hinge is connected to a first object and another end plate of the hinge is connected to a second object. The hinge allows the first object to be selectively angled relative to the second object. The plates are each movable relative to another one of the plates about a pivot axis that connects one of the plates with another one of the plates, thus providing a plurality of pivot axes to allow the angle between each of the plates to be selectively adjusted. This allows the hinge to bend along the length of the hinge, which is not possible with conventional hinges that pivot components of the hinge about a single axis.

In one embodiment, in accordance with the principles of the present disclosure, the hinge includes a first end plate, a second end plate and at least one inner plate positioned between the first end plate and the second end plate. The first end plate is connected to the at least one inner plate by a first pin that extends through the first end plate and the at least one inner plate. The second end plate is connected to the at least one inner plate by a second pin that extends through the first end plate and the at least one inner plate. The first end plate is rotatable relative to the at least one inner plate about a first pivot axis defined by the first pin. The second end plate is rotatable relative to the at least one inner plate about a second pivot axis defined by the second pin.

### BRIEF DESCRIPTION OF THE DRAWINGS

The present disclosure will become more readily apparent from the specific description accompanied by the following drawings, in which:

FIG. 1 is a perspective view of a hinge in accordance with the principles of the present disclosure;

FIG. 2 is an perspective view of the hinge shown in FIG. 1;

FIG. 3 is a side view of the hinge shown in FIG. 1 connected with a first object and a second object;

FIG. 4 is a perspective view of a component of the hinge shown in FIG. 1;

FIG. 5 is a perspective view of the component shown in FIG. 4;

FIG. 6 is an end view of the component shown in FIG. 4;

FIG. 7 is a cross sectional view of the component shown in FIG. 4 taken along lines A-A in FIG. 6;

FIG. 8 is a side view of the component shown in FIG. 4;

FIG. 9 is a cross sectional view of the component shown in FIG. 4 taken along lines B-B in FIG. 8;

FIG. 10 is an view of the component shown in FIG. 4;

FIG. 11 is a top view of the component shown in FIG. 4;

FIG. 12 is a perspective view of a component of the hinge shown in FIG. 1;

FIG. 13 is a perspective view of the component shown in FIG. 12;

FIG. 14 is an end view of the component shown in FIG. 12;

FIG. 15 is a cross sectional view of the component shown in FIG. 12 taken along lines C-C in FIG. 14;

FIG. 16 is a side view of the component shown in FIG. 12;

FIG. 17 is a cross sectional view of the component shown in FIG. 12 taken along lines D-D in FIG. 16;

FIG. 18 is an end view of the component shown in FIG. 12;

FIG. 19 is a top view of the component shown in FIG. 12;

FIG. 20 is a perspective view of a component of the hinge shown in FIG. 1;

FIG. 21 is a perspective view of the component shown in FIG. 20;

FIG. 22 is an end view of the component shown in FIG. 20;

FIG. 23 is a cross sectional view of the component shown in FIG. 20 taken along lines E-E in FIG. 22;

FIG. 24 is a side view of the component shown in FIG. 20;

FIG. 25 is a cross sectional view of the component shown in FIG. 20 taken along lines F-F in FIG. 24;

FIG. 26 is an end view of the component shown in FIG. 20;

FIG. 27 is a top view of the component shown in FIG. 20;

FIG. 28 is a perspective view of a component of the hinge shown in FIG. 1;

FIG. 29 is a perspective view of a component of the hinge shown in FIG. 1;

FIG. 30 is a cross sectional view of the component shown in FIG. 29;

FIG. 31 is a perspective view of a hinge in accordance with the principles of the present disclosure;

FIG. 32 is a perspective view of a hinge in accordance with the principles of the present disclosure;

FIG. 33 is a side view of a hinge in accordance with the principles of the present disclosure;

FIG. 34 is a side view of a hinge in accordance with the principles of the present disclosure;

FIG. 35 is a side view of a hinge in accordance with the principles of the present disclosure;

FIG. 36 is a perspective view of a hinge in accordance with the principles of the present disclosure;

FIG. 37 is a perspective view of the hinge shown in FIG. 36;

FIG. 38 is a perspective view of the hinge shown in FIG. 36;

FIG. 39 is a perspective view of a hinge in accordance with the principles of the present disclosure;

FIG. 40 is a perspective view of the hinge shown in FIG. 39;

FIG. 41 is a side view of the hinge shown in FIG. 39;

FIG. 42 is a perspective view of the hinge shown in FIG. 39;

FIG. 43 is a perspective view of a hinge in accordance with the principles of the present disclosure;

FIG. 44 is a perspective view of the hinge shown in FIG. 43;

FIG. 45 is a perspective view of the hinge shown in FIG. 43, with parts separated;

FIG. 46 is a perspective view of the hinge shown in FIG. 43, with parts separated;

FIG. 47 is a perspective view of a hinge in accordance with the principles of the present disclosure;

FIG. 48 is a perspective view of a hinge in accordance with the principles of the present disclosure;

FIG. 49 is a perspective view of the hinge shown in FIG. 48;

FIG. 50 is a perspective view of a hinge in accordance with the principles of the present disclosure;

FIG. 51 is a perspective view of the hinge shown in FIG. 50;

FIG. 52 is a perspective view of a hinge in accordance with the principles of the present disclosure; and

FIG. 53 is a perspective view of the hinge shown in FIG. 52.

Like reference numerals indicate similar parts throughout the figures.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior.”

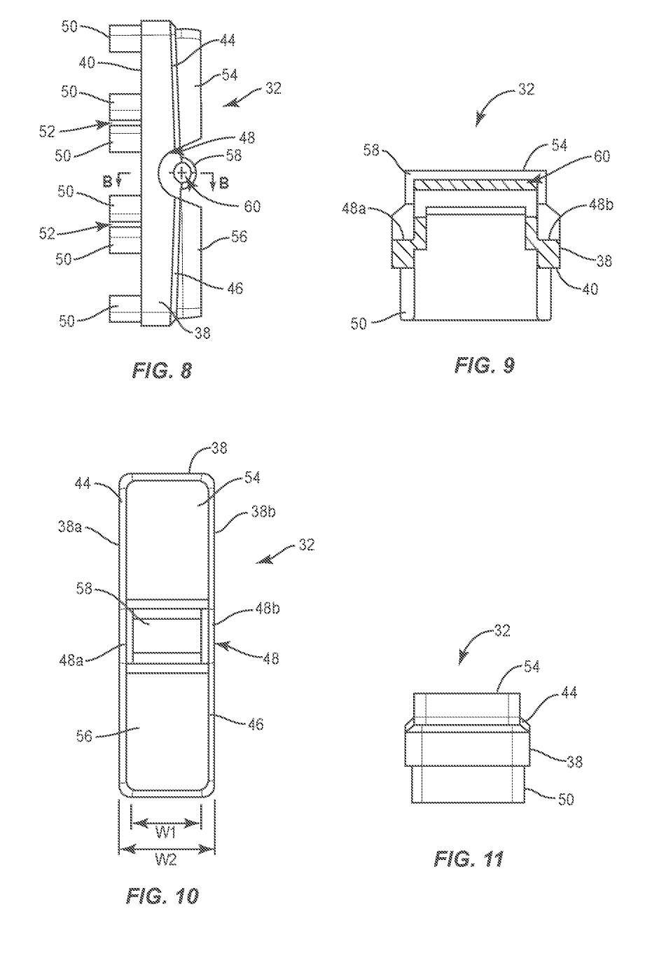

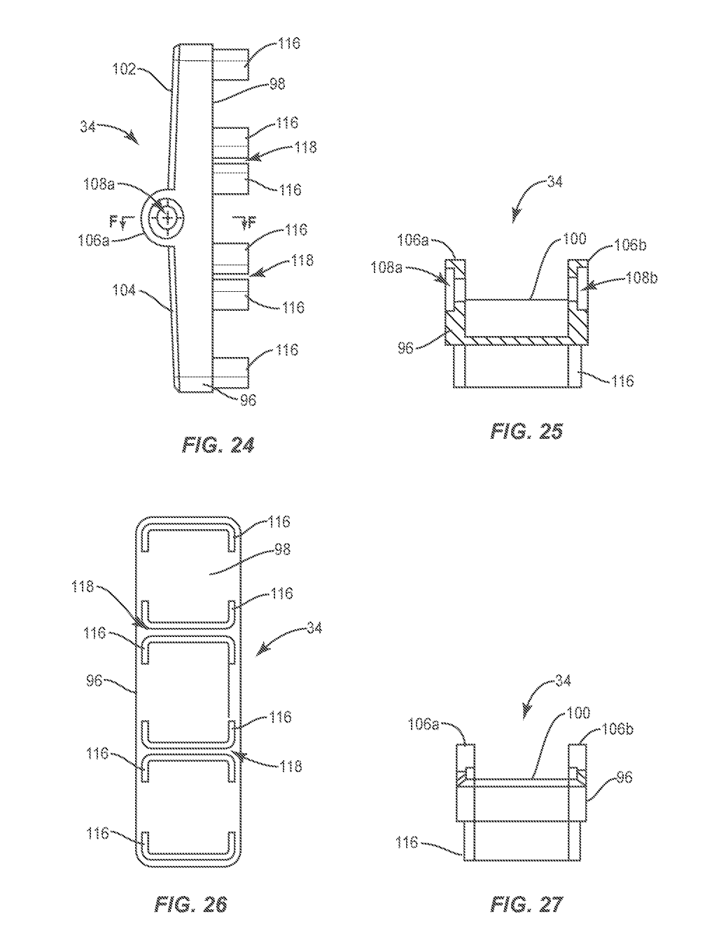

Reference will now be made in detail to the exemplary embodiments of the present disclosure, which are illustrated in the accompanying figures. Turning to FIGS. 1-30, there are illustrated components of a hinge 30.

Hinge 30 is configured to connect a first object, such as, for example, a first portion of a rail, with a second object, such as, for example, a second portion of a rail in order to rotate the first object relative to the second object. Hinge 30 includes an end plate 32, an end plate 34 and one or more inner plates 36 between end plate 32 and end plate 34.

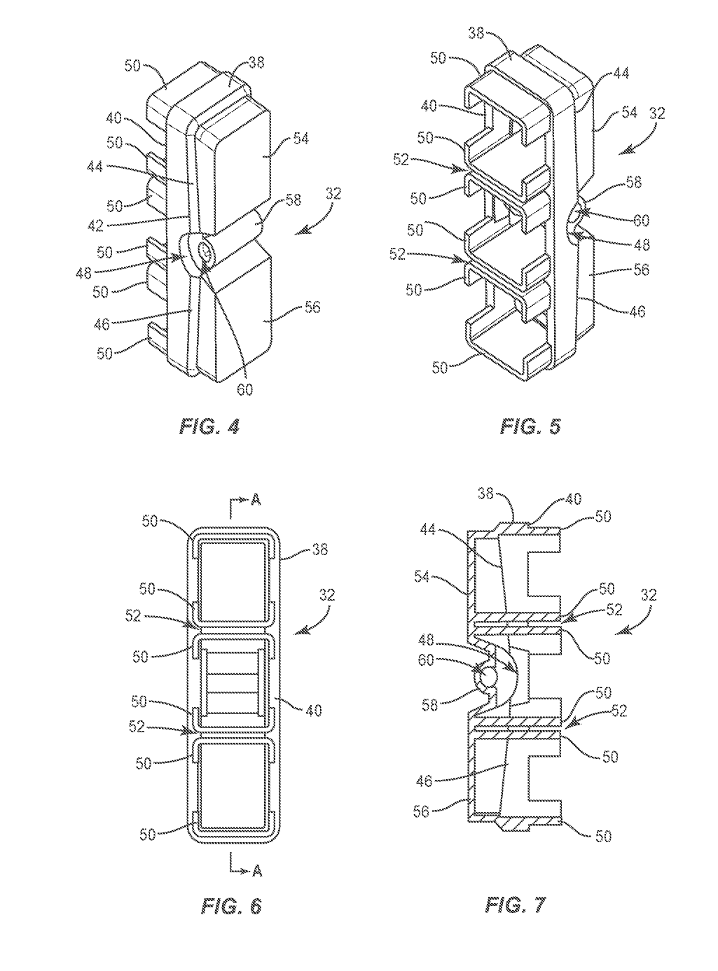

As shown in FIGS. 4-11, end plate 32 includes a body 38 having a planar surface 40 and a surface 42 opposite surface 40. Surface 42 includes an inclined portion 44, an inclined portion 46 and a concave recessed portion 48 positioned between inclined portion 44 and inclined portion 46. Inclined portions 44, 46 each extend transverse to surface 40. In some embodiments, inclined portions 44, 46 each extend at an acute angle relative to surface 40. End plate 32 includes one or a plurality of projections 50 that extend from surface 40. Projections 50 are configured for disposal in a cavity of the first object or the second object, as discussed herein. In some embodiments, projections 50 are integrally formed with body 38. In some embodiments, end plate 32 includes only one projection 50. In such embodiments, projection 50 may extend continuously around a perimeter of body 38. In some embodiments, end plate 32 includes a plurality of projections 50. In some embodiments, at least one of projections 50 is spaced apart from another one of projections 50 by a gap 52. Gap 52 is configured for disposal of a wall of the first object or the second object, as discussed herein.

In some embodiments, two of projections 50 are configured to fit within a first cavity in the first object or the second object, two of projections 50 are configured to fit within a second cavity in the first object or the second object and two of projections 50 are configured to fit within a third cavity in the first object or the second object. It is envisioned that projections 50 that fit within the first cavity can have a size and shape that conforms to that of the first cavity; that projections 50 that fit within the second cavity can have a size and shape that conforms to that of the second cavity; and that projections 50 that fit within the third cavity can have a size and shape that conforms to that of the third cavity. In some embodiments, the cavities each have the same size and shape such that the projections 50 that fit within the first cavity will be the same as the projections 50 that fit within the second cavity and the projections 50 that fit within the third cavity. In some embodiments, the projections 50 that are configured to fit within the first cavity are spaced apart from one another to allow those projections 50 to move relative to one another to accommodate positioning those projections 50 within the first cavity; the projections 50 that are configured to fit within the second cavity are spaced apart from one another to allow those projections 50 to move relative to one another to accommodate positioning those projections 50 within the second cavity; and the projections 50 that are configured to fit within the third cavity are spaced apart from one another to allow those projections 50 to move relative to one another to accommodate positioning those projections 50 within the third cavity. That is, the projections 50 that fit into a respective one of the cavities in the first or second object can move toward or away from one another due to their spaced apart relationship in order to fit the projections 50 into the cavity. In some embodiments, projections 50 are made from a resilient material such that one of projections 50 can be moved toward another one of projections 50 upon the application of force to one or both of the projections 50 and then move away from one another after the force is removed.

End plate 32 includes a block 54 that extends from inclined portion 44 of surface 42 and a block 56 that extends from inclined portion 46 of surface 42. Blocks 54, 56 are configured for disposal within inner plate 36 to couple inner plate 36 to end plate 34, as discussed herein. In some embodiments, blocks 54, 56 each include a surface opposite surface 40 that extends parallel to surface 40. Block 54 is connected to block 56 by a cylindrical portion 58 of end plate 32. Cylindrical portion 58 includes an inner surface that defines a passageway 60 that extends continuously through cylindrical portion 58. Cylindrical portion 58 is centrally positioned between opposite sidewalls 38a, 38b of body 38, as shown in FIG. 10, for example. Cylindrical portion 58 has a width w1 that is less than a width w2 of body 38 to define a recessed portion 48a of surface 42 on one end of cylindrical portion 58 and a recessed portion 48b of surface 42 on an opposite end of cylindrical portion 58, as shown in FIG. 10, for example. Passageway 60 is configured for disposal of a pin that extends through passageway 60 and a portion of inner plate 36 to allow inner plate 36 to pivot relative to end plate 32, as discussed herein.

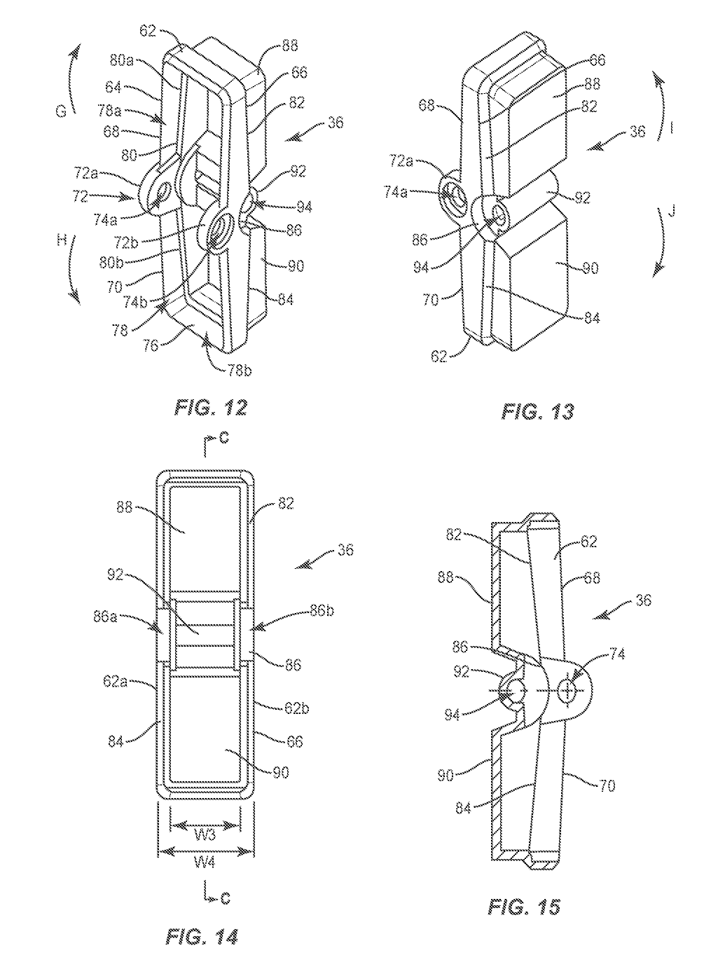

Inner plate 36 connects to end plate 32 and includes a body 62 having a surface 64 and a surface 66 opposite surface 64. Surface 64 includes an inclined portion 68, an inclined portion 70 and a convex extension 72 positioned between inclined portion 68 and inclined portion 70, as shown in FIGS. 12-19, for example. Inner plate 36 includes an aperture 74 that extends through extension 72. In some embodiments, aperture 74 extends through a portion of body 62. An inner surface 76 of body 62 defines a cavity 78 configured for disposal of blocks 54, 56 of end plate 32, as discussed herein. In particular, cavity 78 includes a section 78a configured for disposal of block 54 and a section 78b configured for disposal of block 56. Inner surface 76 defines a flange 80 having a portion 80a and a portion 80b that extends transverse to portion 80a. Portions 80a, 80b are configured to engage surfaces of blocks 54, 56 as inner plate 36 pivots relative to end plate 32, as discussed herein. Cavity 78 divides extension 72 into an extension 72a and an extension 72b and aperture 74 into an aperture 74a and an aperture 74b. Aperture 74a is in extension 72a and aperture 74b is in extension 72b.

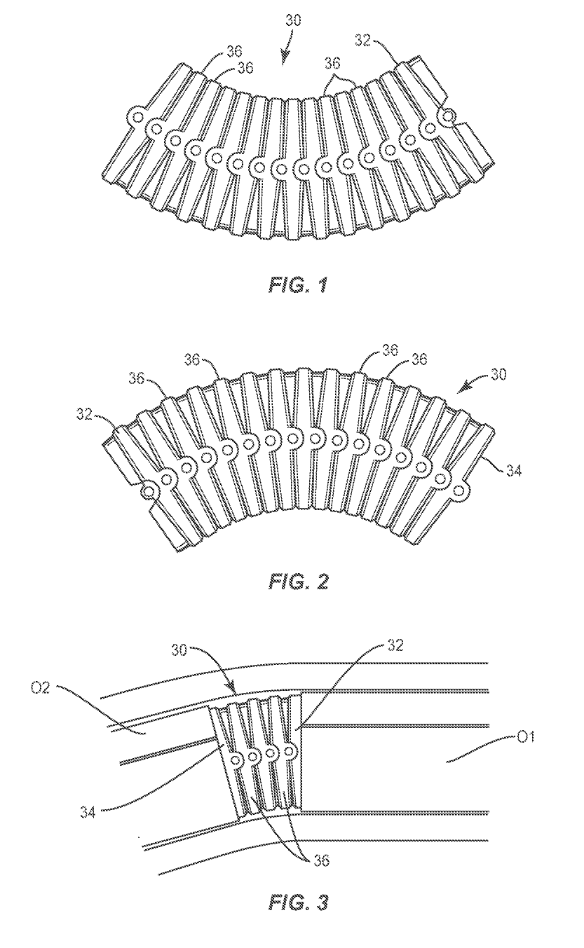

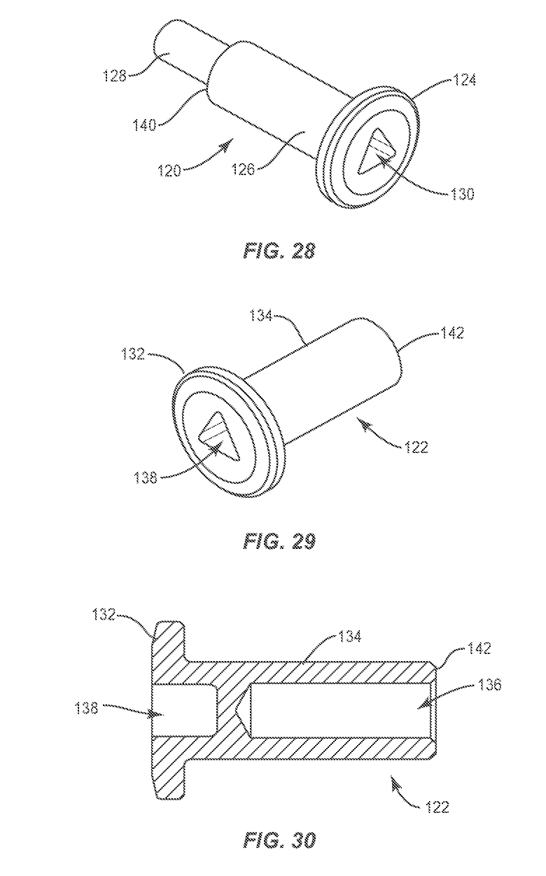

Inner plate 36 is positioned relative to end plate 32 such that block 54 of end plate 32 is positioned within section 78a of cavity 78 of inner plate 36 and block 56 of end plate 32 is positioned within section 78b of cavity 78 of inner plate 36. Extension 72 of inner plate 36 is positioned within recessed portion 48 of end plate 32 such that an outer surface of extension 72a engages recessed portion 48a and an outer surface of extension 72b engages recessed portion 48b and passageway 60 of end plate 32 is aligned with aperture 74 of inner plate 36. A pin, such as, for example, the pin shown in FIGS. 28-30 is positioned through passageway 60 and aperture 74 to connect inner plate 36 to end plate 32 such that inner plate 36 is pivotable relative to end plate 32 about a pivot axis defined by the pin that extends through passageway 60 and aperture 74. Inner plate 36 is pivotable relative to end plate 32 about the pivot axis in a first direction, such as, for example, the direction shown by arrow G in FIG. 12 and a second direction, such as, for example, the direction shown by arrow H in FIG. 12. Blocks 54, 56 of end plate 32 move within sections 78a, 78b of cavity 78 as inner plate 36 pivots relative to end plate 32. Inner plate 36 is pivotable relative to end plate 32 about the pivot axis in the first direction shown by arrow G in FIG. 12 until a planar surface of block 54 engages portion 80a of flange 80 and a planar surface of block 56 is spaced apart from portion 80b of flange 80. Inner plate 36 is pivotable relative to end plate 32 about the pivot axis in the second direction shown by arrow H in FIG. 12 until the planar surface of block 56 engages portion 80b of flange 80 and the planar surface of block 54 is spaced apart from portion 80a of flange 80. As would be apparent to one of ordinary skill in the art, pivoting inner plate 36 relative to end plate 32 about the pivot axis in the first direction shown by arrow G in FIG. 12 causes the top surface of hinge 30 to have a concave configuration, as shown in FIG. 1. Likewise, pivoting inner plate 36 relative to end plate 32 about the pivot axis in the second direction shown by arrow H in FIG. 12 causes the top surface of hinge 30 to have a convex configuration, as shown in FIG. 2.

Surface 66 of inner plate 36 includes an inclined portion 82, an inclined portion 84 and a concave recessed portion 86 positioned between inclined portion 82 and inclined portion 84. Inclined portion 82 extends transverse to inclined portion 84. Inner plate 36 includes a block 88 that extends from inclined portion 82 of surface 66 and a block 90 that extends from inclined portion 84 of surface 66. In some embodiments, blocks 88, 90 are configured for disposal within cavity 78 of another inner plate 36 to couple one inner plate 36 to another inner plate 36, as discussed herein. In some embodiments, blocks 88, 90 are configured for disposal within endplate 34 to couple inner plate 36 to end plate 34, as discussed herein. In some embodiments, blocks 88, 90 each include a planar surface opposite surface 66. In some embodiments, the planar surfaces of blocks 88, 90 extend parallel to one another. In some embodiments, the planar surfaces of blocks 88, 90 are co-planar.

Block 88 is connected to block 90 by a cylindrical portion 92 of inner plate 36. Cylindrical portion 92 includes an inner surface that defines a passageway 94 that extends continuously through cylindrical portion 92. Cylindrical portion 92 is centrally positioned between opposite sidewalls 62a, 62b of body 62, as shown in FIG. 14, for example. Cylindrical portion 94 has a width w3 that is less than a width w4 of body 62 to define a recessed portion 86a of surface 66 on one end of cylindrical portion 94 and a recessed portion 86b of surface 66 on an opposite end of cylindrical portion 94, as shown in FIG. 14, for example. In some embodiments, passageway 94 is configured for disposal of a pin, such as, for example, the pin shown in FIGS. 28-30 that extends through passageway 94 and aperture 74 of another inner plate 36 to allow the inner plate 36 that is connected to end plate 32 to pivot relative to another inner plate 36, as discussed herein. In some embodiments, passageway 94 is configured for disposal of a pin, such as, for example, the pin shown in FIGS. 28-30 that extends through a portion of end plate 34 to allow inner plate 36 to pivot relative to end plate 34, as discussed herein.

In embodiments wherein the inner plate 36 that is connected to end plate 32 is also connected to an additional inner plate 36, blocks 88, 90 of the inner plate 36 that is connected to end plate 32 are positioned within cavity 78 of the additional inner plate 36. In particular, block 88 of the inner plate 36 that is connected to end plate 32 is positioned within cavity 78a of the additional inner plate 36 and block 90 of the inner plate 36 that is connected to end plate 32 is positioned within cavity 78b of the additional inner plate 36. Extension 72 of the additional inner plate 36 is positioned within recessed portion 86 of the inner plate 36 that is connected to end plate 32 such that an outer surface of extension 72a of the additional inner plate 36 engages recessed portion 86a of the inner plate 36 that is connected to end plate 32 and an outer surface of extension 72b of the additional inner plate 36 engages recessed portion 86b of the inner plate 36 that is connected to end plate 32 and aperture 74 of the additional inner plate 36 is aligned with passageway 94 of the inner plate 36 that is connected to end plate 32.

A pin, such as, for example, the pin shown in FIGS. 28-30 is positioned through passageway 94 and aperture 74 to connect the additional inner plate 36 with the inner plate 36 that is connected to end plate 32 such that the additional inner plate 36 is pivotable relative to the inner plate 36 that is connected to end plate 32 about a pivot axis defined by the pin that extends through passageway 94 and aperture 74. The additional inner plate 36 is pivotable relative to the inner plate 36 that is connected to end plate 32 about the pivot axis defined by the pin that extends through passageway 94 and aperture 74 in a first direction, such as, for example, the direction shown by arrow I in FIG. 13 and a second direction, such as, for example, the direction shown by arrow J in FIG. 13. Blocks 88, 90 of the inner plate 36 that is connected to end plate 32 move within sections 78a, 78b of cavity 78 of the additional inner plate 36 as the additional inner plate 36 pivots relative to the inner plate 36 that is connected to end plate 32. The additional inner plate 36 is pivotable relative to the inner plate 36 that is connected to end plate 32 about the pivot axis defined by the pin that extends through passageway 94 and aperture 74 in the first direction shown by arrow I in FIG. 13 until inclined portion 68 of the additional inner plate 36 engages inclined portion 82 of the inner plate 36 that is connected to end plate 32 and inclined portion 70 of the additional inner plate 36 is spaced apart from inclined portion 84 of the inner plate 36 that is connected to end plate 32. The additional inner plate 36 is pivotable relative to the inner plate 36 that is connected to end plate 32 about the pivot axis defined by the pin that extends through passageway 94 and aperture 74 in the second direction shown by arrow J in FIG. 13 until inclined portion 70 of the additional inner plate 36 engages inclined portion 84 of the inner plate 36 that is connected to end plate 32 and inclined portion 68 of the additional inner plate 36 is spaced apart from inclined portion 82 of the inner plate 36 that is connected to end plate 32. As would be apparent to one of ordinary skill in the art, pivoting the additional inner plate 36 relative to the inner plate 36 that is connected to end plate 32 about the pivot axis defined by the pin that extends through passageway 94 and aperture 74 in the first direction shown by arrow I in FIG. 13 causes the top surface of hinge 30 to have a concave configuration, as shown in FIG. 1. Likewise, pivoting the additional inner plate 36 relative to the inner plate 36 that is connected to end plate 32 about the pivot axis defined by the pin that extends through passageway 94 and aperture 74 in the second direction shown by arrow J in FIG. 13 causes the top surface of hinge 30 to have a convex configuration, as shown in FIG. 2.

The pivot axis defined by the pin that extends through passageway 94 and aperture 74 extends parallel to the pivot axis defined by the pin that extends through passageway 60 of end plate 32 and aperture 74 of the inner plate 36 that is connected to end plate 32. Hinge 30 thus includes at least two pivot axes along the length of hinge 30 to allow hinge 30 to bend in at least two places along the length of hinge 30. It is envisioned that hinge 30 may include any number of additional inner plates 36 that are connected to the inner plate 36 that is connected to end plate 32. For example, hinge 30 may include one, two, three, four, five, six, seven, eight, nine, ten, eleven, twelve, thirteen, fourteen, fifteen, sixteen, seventeen, eighteen, nineteen, twenty, twenty one, twenty two, twenty three, twenty four, twenty five, etc. additional inner plates 36 that are connected to the inner plate 36 that is connected to end plate 32. The additional inner plates 36 are connected to one another in the manner the additional inner plate 36 is connected to the inner plate 36 that is connected to end plate 32 discussed above. As would be appreciated by one of ordinary skill in the art, adding additional inner plates 36 to the inner plate 36 that is connected to end plate 32 provides hinge 30 with additional pivot axes along the length of hinge 30. For example, adding two inner plates 36 to the inner plate 36 that is connected to end plate 32 provides hinge 30 with two pivot axes along the length of hinge 30, in addition to the pivot axis defined by the pin that extends through passageway 60 of end plate 32 and aperture 74 of the inner plate 36 that is connected to end plate 32. Likewise, adding three inner plates 36 to the inner plate 36 that is connected to end plate 32 provides hinge 30 with three pivot axes along the length of hinge 30, in addition to the pivot axis defined by the pin that extends through passageway 60 of end plate 32 and aperture 74 of the inner plate 36 that is connected to end plate 32. The number of additional inner plates 36 that is/are added to the inner plate 36 that is connected to end plate 32 may therefore be selected depending upon the number of pivot axes that are desired along the length of hinge 30. In that the number of pivot axes along the length of hinge 30 correlates to the amount of bend hinge 30 has along the length of hinge 30, the number of additional inner plates 36 may thus be selected based upon the amount of bend desired along the length of hinge 30.

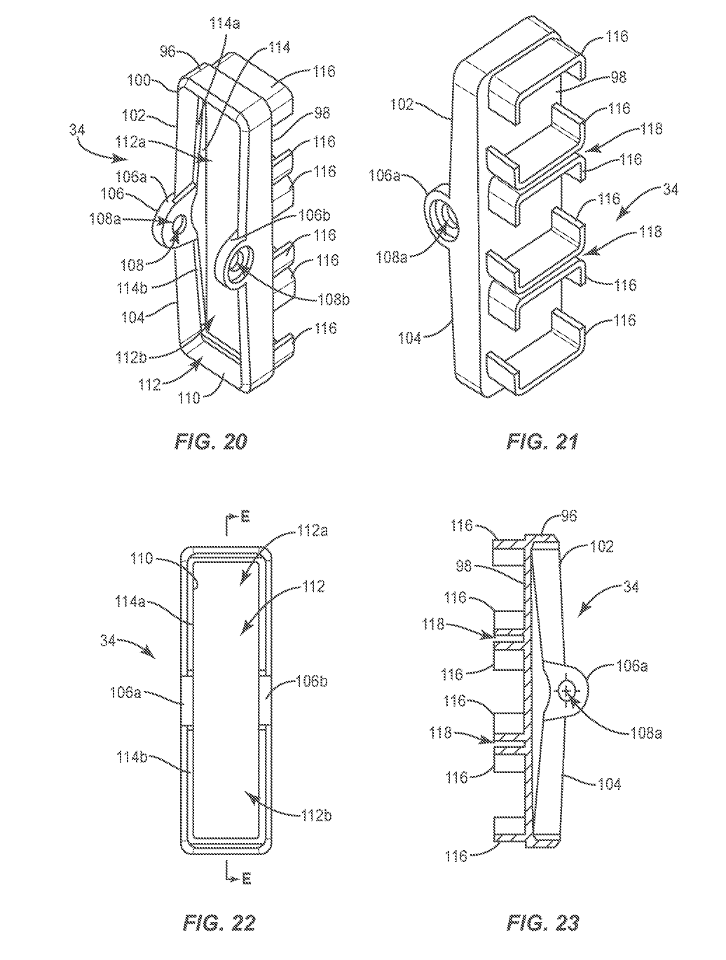

As shown in FIGS. 20-27, end plate 34 includes a body 96 having a planar surface 98 and a surface 100 opposite surface 98. Surface 100 includes an inclined portion 102, an inclined portion 104 and a convex extension 106 positioned between inclined portion 102 and inclined portion 104. An aperture 108 extends through extension 106. In some embodiments, aperture 108 extends through a portion of body 96. An inner surface 110 of body 96 defines a cavity 112 configured for disposal of blocks 88, 90 of inner plate 36, as discussed herein. In particular, cavity 112 includes a section 112a configured for disposal of block 88 and a section 112b configured for disposal of block 90. Inner surface 110 defines a flange 114 having a portion 114a and a portion 114b that extends transverse to portion 114a. Portions 114a, 114b are configured to engage surfaces of blocks 88, 90 as inner plate 36 pivots relative to end plate 34, as discussed herein. Cavity 112 divides extension 106 into an extension 106a and an extension 106b and aperture 108 into an aperture 108a and an aperture 108b. Aperture 108a is in extension 106a and aperture 108b is in extension 106b.

Inclined portions 102, 104 each extend transverse to surface 98. In some embodiments, inclined portions 102, 104 each extend at an acute angle relative to surface 98. End plate 34 includes one or a plurality of projections 116 that extend from surface 98. Projections 116 are configured for disposal in a cavity of the first object or the second object, as discussed herein. In some embodiments, projections 116 are integrally formed with body 96. In some embodiments, end plate 34 includes only one projection 116. In such embodiments, projection 116 may extend continuously around a perimeter of body 96. In some embodiments, end plate 34 includes a plurality of projections 116. In some embodiments, at least one of projections 116 is spaced apart from another one of projections 116 by a gap 118. Gap 118 is configured for disposal of a wall of the first object or the second object, as discussed herein.

In some embodiments, two of projections 116 are configured to fit within a first cavity in the first object or the second object, two of projections 116 are configured to fit within a second cavity in the first object or the second object and two of projections 116 are configured to fit within a third cavity in the first object or the second object. It is envisioned that projections 116 that fit within the first cavity can have a size and shape that conforms to that of the first cavity; that projections 116 that fit within the second cavity can have a size and shape that conforms to that of the second cavity; and that projections 116 that fit within the third cavity can have a size and shape that conforms to that of the third cavity. In some embodiments, the cavities each have the same size and shape such that the projections 116 that fit within the first cavity will be the same as the projections 116 that fit within the second cavity and the projections 116 that fit within the third cavity. In some embodiments, the projections 116 that are configured to fit within the first cavity are spaced apart from one another to allow those projections 116 to move relative to one another to accommodate positioning those projections 116 within the first cavity; the projections 116 that are configured to fit within the second cavity are spaced apart from one another to allow those projections 116 to move relative to one another to accommodate positioning those projections 116 within the second cavity; and the projections 116 that are configured to fit within the third cavity are spaced apart from one another to allow those projections 116 to move relative to one another to accommodate positioning those projections 116 within the third cavity. That is, the projections 116 that fit into a respective one of the cavities in the first or second object can move toward or away from one another due to their spaced apart relationship in order to fit the projections 116 into the cavity. In some embodiments, projections 116 are made from a resilient material such that one of projections 116 can be moved toward another one of projections 116 upon the application of force to one or both of the projections 116 and then move away from one another after the force is removed.

Inner plate 36 connects to end plate 34. Inner plate 36 is positioned relative to end plate 34 such that block 88 of inner plate 36 is positioned within section 112a of cavity 112 of end plate 34 and block 90 of inner plate 36 is positioned within section 112b of cavity 112 of end plate 34. Extension 106 of end plate 34 is positioned within recessed portion 86 of inner plate 36 such that an outer surface of extension 106a engages recessed portion 86a and an outer surface of extension 106b engages recessed portion 86b and passageway 94 of inner plate 36 is aligned with aperture 108 of end plate 34. A pin, such as, for example, the pin shown in FIGS. 28-30 is positioned through passageway 94 and aperture 108 to connect inner plate 36 to end plate 34 such that inner plate 36 is pivotable relative to end plate 34 about a pivot axis defined by the pin that extends through passageway 94 and aperture 108.

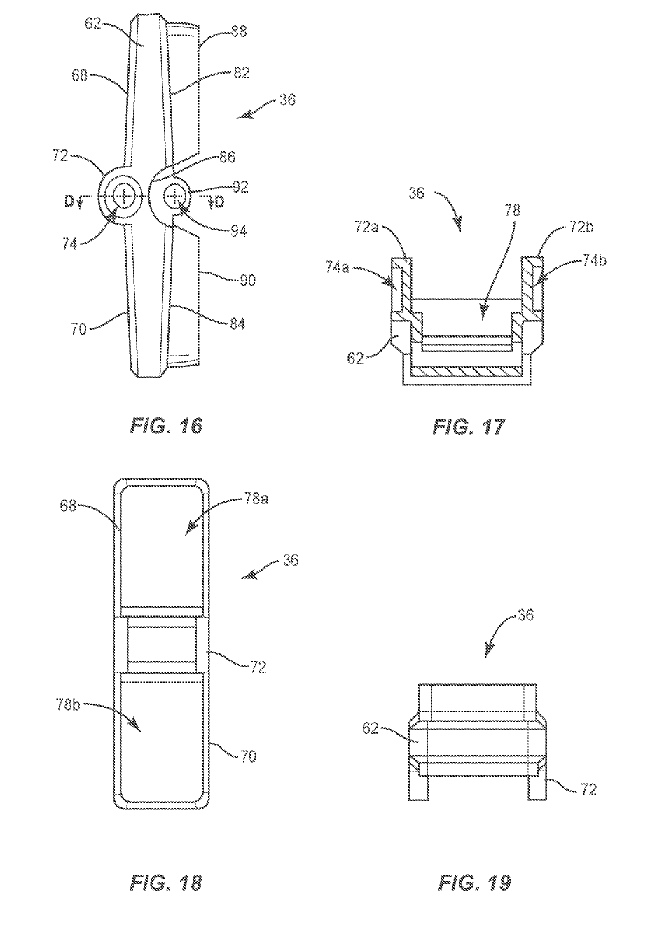

Inner plate 36 is pivotable relative to end plate 34 about the pivot axis defined by the pin that extends through passageway 94 and aperture 108 in a first direction, such as, for example, the direction shown by arrow K in FIG. 16 and a second direction, such as, for example, the direction shown by arrow L in FIG. 16. Blocks 88, 90 of inner plate 36 move within sections 112a, 112b of cavity 112 of end plate 34 as inner plate 36 pivots relative to end plate 34. Inner plate 36 is pivotable relative to end plate 34 about the pivot axis defined by the pin that extends through passageway 94 and aperture 108 in the first direction shown by arrow K in FIG. 16 until a planar surface of block 88 engages portion 114a of flange 114 and a planar surface of block 90 is spaced apart from portion 114b of flange 114. Inner plate 36 is pivotable relative to end plate 34 about the pivot axis defined by the pin that extends through passageway 94 and aperture 108 in the second direction shown by arrow L in FIG. 16 until the planar surface of block 90 engages portion 114b of flange 114 and the planar surface of block 88 is spaced apart from portion 114a of flange 114. As would be apparent to one of ordinary skill in the art, pivoting inner plate 36 relative to end plate 34 about the pivot axis defined by the pin that extends through passageway 94 and aperture 108 in the first direction shown by arrow K in FIG. 16 causes the top surface of hinge 30 to have a concave configuration, as shown in FIG. 1. Likewise, pivoting inner plate 36 relative to end plate 34 about the pivot axis defined by the pin that extends through passageway 94 and aperture 108 in the second direction shown by arrow L in FIG. 16 causes the top surface of hinge 30 to have a convex configuration, as shown in FIG. 2.

The pivot axis defined by the pin that extends through passageway 94 and aperture 108 extends parallel to the pivot axis defined by the pin that extends through passageway 94 and aperture 74 and parallel to the pivot axis defined by the pin that extends through passageway 60 of end plate 32 and aperture 74 of the inner plate 36 that is connected to end plate 32. Hinge 30 thus includes at least three pivot axes along the length of hinge 30 to allow hinge 30 to bend in at least three places along the length of hinge 30.

In operation and use, hinge 30 is assembled with end plate 32 connected to one of inner plates 36 and end plate 34 connected to the inner plate 36 that is connected to end plate 32 or an additional inner plate 36 that is connected to the inner plate 36 that is connected to end plate 32, as discussed herein. End plate 32 may be connected to a first object O1, such as, for example, a first rail of a frame, as shown in FIG. 3. End plate 32 is connected with first object O1 by inserting at least one of extensions 50 into a cavity in first object O1. End plate 34 may be connected to a second object O2, such as, for example, a second rail of a frame, as shown in FIG. 3. End plate 34 is connected with second object O2 by inserting at least one of extensions 116 into a cavity in second object O2. Alternatively, end plate 34 may be connected with second object O2 by inserting at least one of extensions 116 into a cavity in second object O2 and end plate 32 may be connected to first object O1 by inserting at least one of extensions 50 into a cavity in first object O2. In some embodiments, hinge 30 is sonic welded to at least one of objects O1, O2. It is envisioned that hinge 30 may be used in place of any hinge wherein it is desired to have at least some bend or curvature along the length of the hinge. For example, hinge 30 may be used in place of one or more of the hinges in U.S. Patent Application No. 62/413,717, which is expressly incorporated herein by reference, in its entirety.

End plates 32, 34 and/or inner plate 36 may be manipulated relative to another one of end plates 32, 34 and/or inner plate 36 to provide selected bend or curvature along the length of hinge 30, as discussed herein. For example, end plates 32, 34 and/or inner plate 36 may be manipulated relative to another one of end plates 32, 34 and/or inner plate 36 such that at least a portion of the top surface of hinge 30 is concavely curved along the length of hinge 30 and/or at least a portion of the top surface of hinge 30 is convexly curved along the length of hinge 30. Likewise, end plates 32, 34 and/or inner plate 36 may be manipulated relative to another one of end plates 32, 34 and/or inner plate 36 such that at least a portion of the bottom surface of hinge 30 is concavely curved along the length of hinge 30 and/or at least a portion of the bottom surface of hinge 30 is convexly curved along the length of hinge 30.

As discussed herein, hinge 30 may be provided with the selected bend or curvature along the length of hinge 30 by pivoting the inner plate 36 that is connected to end plate 32 about the pivot axis defined by the pin that extends through passageway 60 of end plate 32 and aperture 74 of inner plate 36 in the direction shown by arrow G in FIG. 12 or the direction shown by arrow H in FIG. 12. The additional inner plate 36 discussed herein may be pivoted relative to the inner plate 36 that is connected to end plate 32 about the pivot axis defined by the pin that extends through passageway 94 and aperture 74 in the direction shown by arrow I in FIG. 13 or the direction shown by arrow J in FIG. 13. Inner plate 36 may be pivoted relative to end plate 34 about the pivot axis defined by the pin that extends through passageway 94 and aperture 108 in the direction shown by arrow K in FIG. 16 or the direction shown by arrow L in FIG. 16.

It is envisioned that the angle of inclined portion 44 of end plate 32, inclined portion 46 of end plate 32, inclined portion 68 of inner plate 36, inclined portion 70 of inner plate 36, inclined portion 82 of inner plate, inclined portion 84 of inner plate 36, inclined portion 102 of end plate 34 and/or inclined portion 104 of end plate 34 can be selected based on the amount of angulation between end plate 32 and inner plate 36, the inner plate 36 that is coupled to end plate 32 and an additional inner plate 36 and/or inner plate 36 and end plate 34. For example, the angle of at least one of the inclined portions discussed herein may be increased where increased angulation is desired and may be decreased where decreased angulation is desired. In some embodiments, the inclined portions discussed herein are angled such that one of endplates 32, 34 and inner plate 36 can pivot between 1 and 20 degrees relative to another one of endplates 32, 34 and inner plate 36. In some embodiments, the inclined portions discussed herein are angled such that one of endplates 32, 34 and inner plate 36 can pivot at least 18 degrees relative to another one of endplates 32, 34 and inner plate 36. In some embodiments, the inclined portions discussed herein are angled such that one of endplates 32, 34 and inner plate 36 can pivot more than 18 degrees relative to another one of endplates 32, 34 and inner plate 36, such as, for example, 19 degrees, 20 degrees, 21 degrees, 22 degrees, 23 degrees, 24 degrees, 25 degrees, 26 degrees, 27 degrees, 28 degrees, 29 degrees, 30 degrees, 31 degrees, 32 degrees, 33 degrees, 34 degrees, 35 degrees, 36 degrees, 37 degrees, 38 degrees, 39 degrees, 40 degrees, etc.

Hinge 30 is distinguishable from other hinges known in the art that bend or provide curvature along the length of the hinge in that the only components that connect end plates 32, 34 and inner plate 36 are the pins discussed herein, the pins extending perpendicular to the length of hinge 30. As discussed herein, the pins define pivot axes that extend parallel to one another such that the components of hinge 30 can pivot relative to one another about the pivot axes to provide bend or curvature along the length of hinge 30. In particular, hinge 30 is free of any rods, pins, cables, cords or the like that extend along at least a portion of the length of hinge 30 to connect at least two of the components of hinge 30.

In some embodiments, the pins discussed above are pins, rods or dowels. The pins may be pins that are known in the art. The pins may be made of a rigid material, such as, for example, a metal or polymer, such as, for example, a plastic. In some embodiments, the pins are made from PVC. In some embodiments, at least one of the pins discussed above is the pin shown in FIGS. 28-30. The pin shown in FIGS. 28-30 includes a part 120, shown in FIG. 28, and a part 122, shown in FIGS. 29 and 30. Part 120 includes a head 124, a shaft 126 coupled to head 124 and an extension 128 that extends from shaft 126. Head 124 includes a socket 130 configured to mate with a bit or tip of a driver to rotate the pin about an axis defined by shaft 126. Part 122 includes a head 132 and a shaft 134 that extends from head 132. Shaft 134 includes a cavity 136 configured for disposal of extension 128. In particular, extension 128 is positioned within cavity 136 to couple part 120 to part 122. Head 132 includes a socket 138 configured to mate with a bit or tip of a driver to rotate the pin about an axis defined by shaft 134. In some embodiments, extension 128 is translated within cavity 136 until a flange 140 of part 120 defined by an interface between shaft 126 and extension 128 engages an end surface 142 of shaft 134. In some embodiments, extension 128 includes an outer thread that is configured to mate with an inner thread of cavity 136 to couple part 120 with part 122 such that rotation of part 120 relative to part 122 and/or part 122 relative to part 120 translates part 120 relative to part 122 along the axis defined by shaft 126 and/or the axis defined by shaft 134.

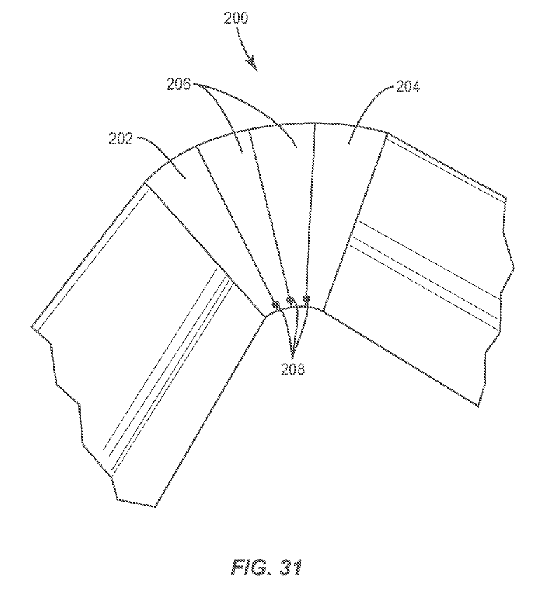

Turning to FIG. 31, there are illustrated components of a hinge 200. Hinge 200 is configured to connect a first object, such as, for example, a first portion of a rail, with a second object, such as, for example, a second portion of a rail in order to rotate the first object relative to the second object. In some embodiments, hinge 200 is a corner hinge. As discussed herein, hinge 200 includes pivot axes that are positioned differently from the pivot axes of hinge 30 discussed above. In particular, the pivot axes of hinge 200 are positioned at one end of hinge 200 to allow an opposite end of hinge 200 to fan out more than would be permitted than if the pivot axes were positioned more centrally between the ends of hinge 200. That is, while hinge 30 permits a rocking motion between components of hinge 30 (e.g., plate 32, plate 34 and/or plate 36), hinge 200 provides greater fanning between components at one end of hinge 200, as discussed herein. Accordingly hinge 200 can be used for corners or places where a greater degree of bending is necessary. I

Hinge 200 includes a section 202 and a section 204. In some embodiments, section 202 is directly coupled to section 204. In some embodiments, hinge 200 includes one or a plurality of sections 206 that are positioned between section 202 and section 204. A pin 208 extends through sections 202 and 206 to allow section 202 to pivot relative to section 206. Likewise, a pin 208 extends through sections 204 and 206 to allow section 204 to pivot relative to section 206. In embodiments that include a plurality of sections 206, a pin 208 also extends through adjacent sections 206 to allow the adjacent sections 206 to pivot relative to one another. In some embodiments, as section 202 pivots relative to section 206, a portion of section 202 rotates within a cavity in section 206 and/or a portion of section 206 rotates within a cavity in section 202. In some embodiments, as section 204 pivots relative to section 206, a portion of section 204 rotates within a cavity in section 206 and/or a portion of section 206 rotates within a cavity in section 204. In some embodiments, as one of sections 206 pivots relative to another one of sections 206, a portion of one of sections 206 rotates within a cavity in another one of sections 206.

Additional embodiments of the hinge 200 having different ranges of motion by repositioning the position of pivot pin 208 are also envisioned as part of the scope of this application. That is, the closer pivot pin 208 is to the outside perimeter of the hinge, the greater the range of bending of the hinge. As the pivot pin 208 is moved more towards the center of the hinge, the range of motion (i.e. bending) is reduced. These restricted range hinges, like hinge 30 described above, are used in places where the desired range of motion is restricted to a more limited scope. Hinges like hinge 200 described above are used where a greater range of motion, like at the corner of a mattress, is required.

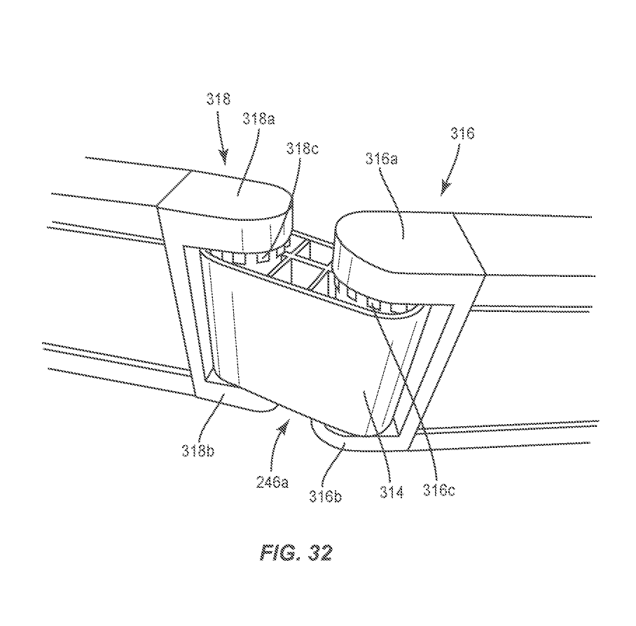

Turning to FIG. 32, there are illustrated components of a hinge 246a. Hinge 246a includes a body 314, a first end portion 316 and a second end portion 318. As shown in FIG. 32, end portion 316 is configured to be fixedly attached to first object and end portion 318 is configured to be fixedly attached to second object. End portion 316 includes spaced apart flanges 316a, 316b. At least one of flanges 316a, 316b includes an extension 316c that is configured for disposal in a cavity of body 314 to allow end portion 316 to pivot relative to body 314. Likewise, end portion 318 includes spaced apart flanges 318a, 318b. At least one of flanges 318a, 318b includes an extension 318c that is configured for disposal in a cavity of body 314 to allow end portion 318 to pivot relative to body 314. When extensions 316c, 318c are disposed in the cavities of body 314, flange 316a is spaced apart from flange 318a and flange 316b is spaced apart from flange 318b, as shown in FIG. 31. This allows end portions 316,318 to move relative to body 314 to move hinge 246a between the first and second orientations discussed herein. In some embodiments, extensions 316c, 318c each have a cylindrical configuration and are disposed in cylindrically shaped cavities in body 314. In some embodiments, all or only a portion of extension 316c and/or extension 318c may be variously configured and dimensioned, such as, for example, planar, concave, polygonal, irregular, uniform, non-uniform, staggered, tapered, consistent or variable, depending on the requirements of a particular application.

Turning to FIGS. 32-35, there are illustrated components of hinges 402a, 402b, 402c. Hinges 402a each include an end plate 420, an end plate 422 and one or more inner plates 424 between end plate 420 and end plate 422. End plate 420 is configured to be fixedly attached to first object and end plate 422 is fixedly attached to second object. End plate 420 includes a block 426 that extends from an inclined surface 428 of end plate 420 and a block 430 that extends from an inclined surface 432 of end plate 420. Blocks 426, 430 are configured for disposal within one of inner plates 424 to couple one of inner plates 424 to end plate 420, as discussed herein. End plate 420 includes a passageway positioned between blocks 426, 430.

A first inner plate 424a includes a body 434 having a surface 436 and a surface 438 opposite surface 436. Surface 436 includes convex extension 440 between inclined portions of surface 436. The first inner plate 424a includes an aperture 442 that extends through extension 440. An inner surface of body 434 defines a cavity configured for disposal of blocks 426, 430. In some embodiments, the cavity of body 434 may include a section configured for disposal of block 426 and a section configured for disposal of block 430. A pin 444 is positioned through the passageway in end plate 420 and aperture 442 to connect the first inner plate 424a to end plate 420 such that inner plate 424a is pivotable relative to end plate 420 about a pivot axis defined by pin 444. Blocks 426, 430 of end plate 420 move within the cavity of first inner plate 424a as inner plate 424a pivots relative to end plate 420.

End plate 422 includes a block 446 that extends from an inclined surface 448 of end plate 422 and a block 450 that extends from an inclined surface 452 of end plate 422. Blocks 446, 450 are configured for disposal within one of inner plates 424 to couple one of inner plates 424 to end plate 422, as discussed herein. End plate 422 includes a passageway 454 positioned between blocks 446, 450.

A second inner plate 424b includes a body 456 having a cavity configured for disposal of blocks 446, 450. Body 456 includes a concave portion 455 positioned between blocks 446, 450. Concave portion 455 includes an aperture. A pin 458 is positioned through passageway 454 and the aperture in body 456 to connect the second inner plate 424b to end plate 422 such that inner plate 424b is pivotable relative to end plate 422 about a pivot axis defined by pin 458. Blocks 446, 450 of end plate 422 move within the cavity of second inner plate 424b as inner plate 424b pivots relative to end plate 422.

In some embodiments, inner plate 424a may be connected directly to inner plate 424b. In some embodiments, hinge 402a includes additional inner plates 424 between inner plate 424a and inner plate 424b, as shown in FIG. 32, for example. While FIG. 32 shows four inner plates 424 between inner plate 424a and inner plate 424b, it is envisioned that hinge 402a may include one or a plurality of additional inner plates 424 between inner plate 424a and inner plate 424b. Hinges 424 may be connected to one another by positioning an extension 440 of a first one of hinges 424 within concave portion 455 of a second one of hinges 424 such that aperture 442 of the first one of hinges 424 is aligned with the aperture in concave portion 455 of the second one of hinges 424. A pin 460 is positioned through aperture 442 of the first one of hinges 424 and the aperture in concave portion 455 of the second one of hinges 424 to allow the first one of hinges 424 to pivot relative to the second one of hinges 424 about pin 460.

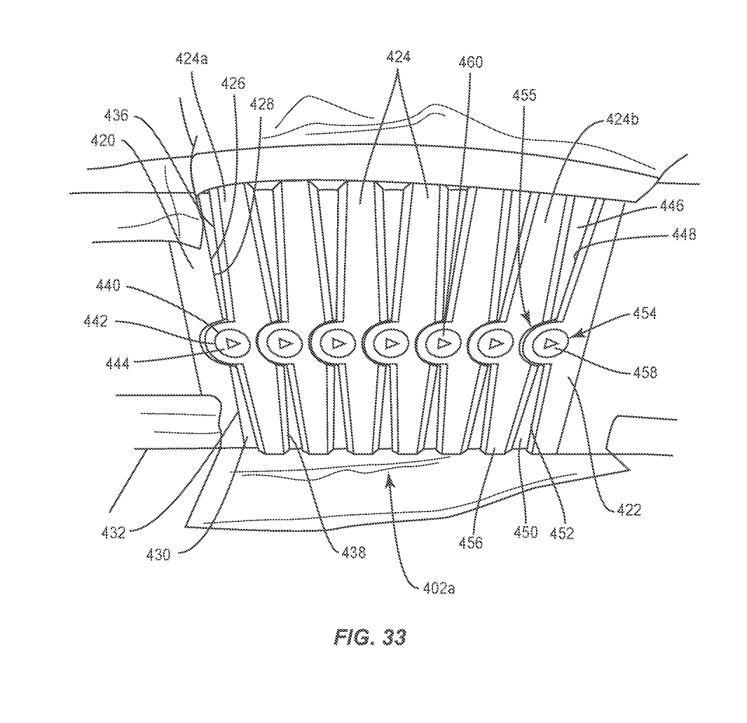

Hinges 402b each include an end plate 462 that is similar or identical to end plate 420, an end plate 464 that is similar or identical to end plate 422 and one or more inner plates 466 between end plate 462 and end plate 464. End plate 462 is configured to be fixedly attached to a first object and end plate 464 is configured to be fixedly attached to a second object. Inner plates 466 may similar or identical to inner plates 424. Accordingly, end plate 462 may be connected to one of inner plates 466 in the manner that end plate 420 is connected to one of inner plates 424 and end plate 464 may be connected to one of inner plates 466 in the manner that end plate 422 is connected to one of inner plates 424. While FIG. 33 shows seventeen inner plates 466 between end plate 462 and end plate 464, it is envisioned that hinge 402b may include one or a plurality of inner plates 466 between end plate 462 and end plate 464.

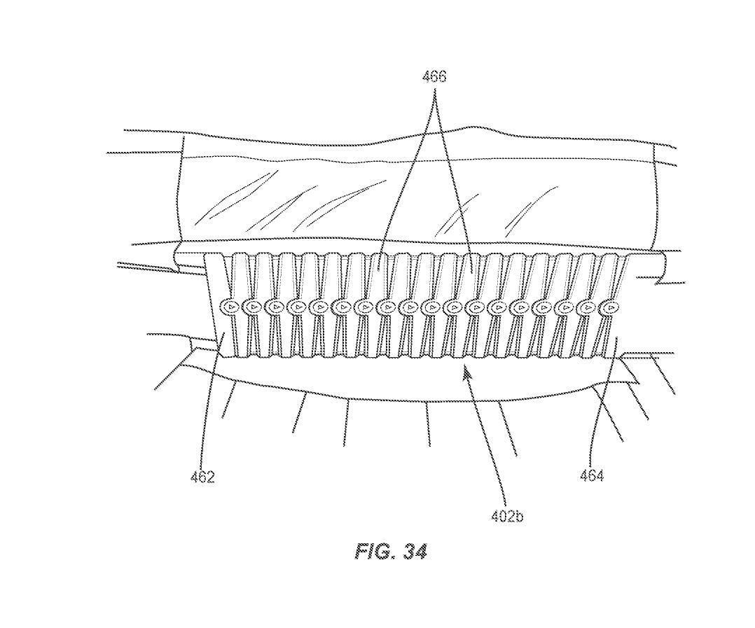

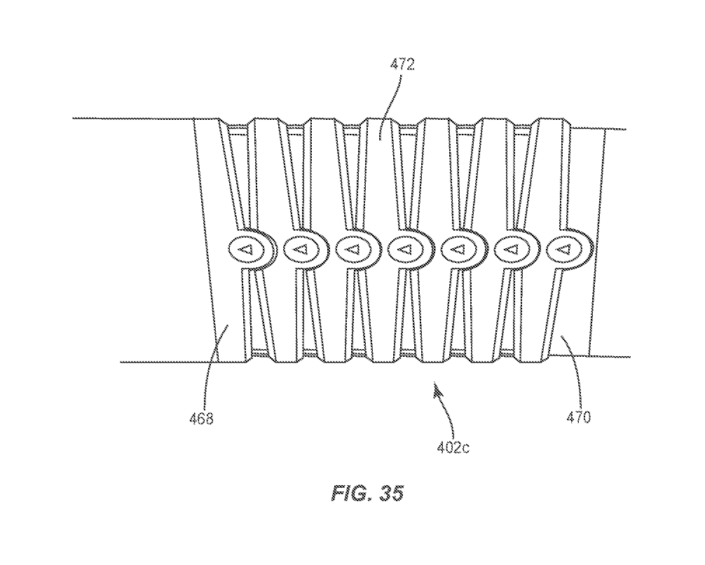

Hinges 402c each include an end plate 468 that is similar or identical to end plate 420 and/or end plate 462, an end plate 470 that is similar or identical to end plate 422 and/or end plate 464 and one or more inner plates 472 between end plate 468 and end plate 470. End plate 468 is configured to be fixedly attached to a first object and end plate 470 is configured to be fixedly attached to a second object. Inner plates 472 may similar or identical to inner plates 424 or inner plates 466. Accordingly, end plate 468 may be connected to one of inner plates 472 in the manner that end plate 420 is connected to one of inner plates 424 or in the manner that end plate 462 is connected to one of inner plates 466. Likewise, end plate 470 may be connected to one of inner plates 472 in the manner that end plate 422 is connected to one of inner plates 424 or in the manner that end plate 464 is connected to one of inner plates 466. While FIG. 34 shows six inner plates 472 between end plate 468 and end plate 470, it is envisioned that hinge 402c may include one or a plurality of inner plates 472 between end plate 468 and end plate 470.

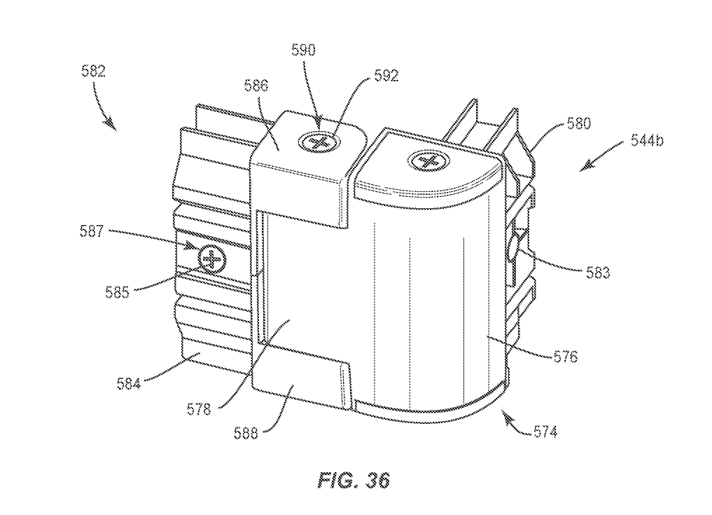

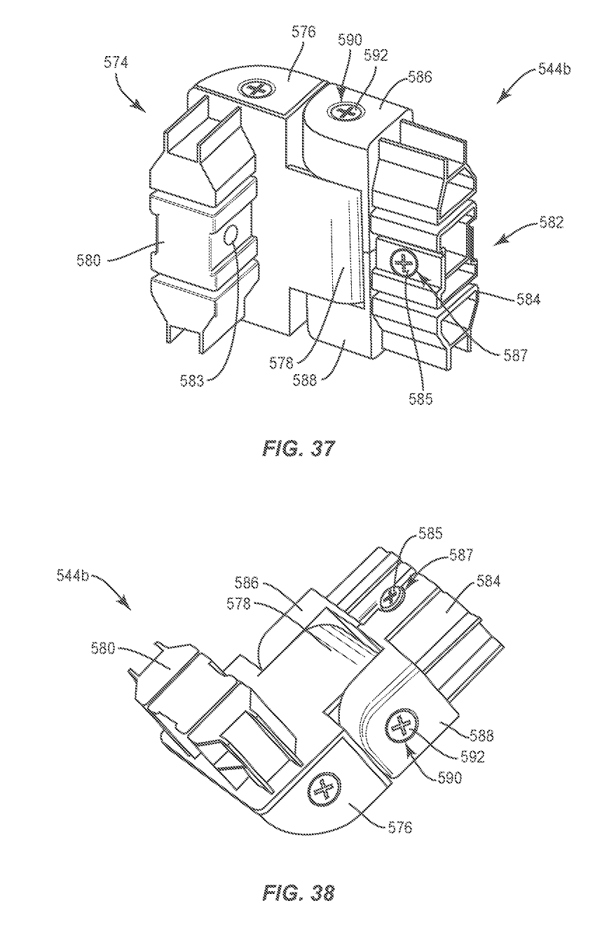

Turning to FIGS. 36-38, there are illustrated components of hinge 554b. Hinge 544b includes a part 574 having a body 576. A first extension 578 extends from one side of body 576 and a second extension 580 extends from another side of body 576 such that extensions 578, 580 are spaced apart from one another. Extension 578 is configured for pivotal engagement with a part 582 of hinge 544b, as discussed herein. Extension 580 is configured for disposal in a cavity of a first object. In some embodiments, extension 580 has a configuration that mates with an inner surface that defines the cavity of the first object. In some embodiments, a fastener, such as, for example, a screw 581 is inserted through an outer surface of the first object and into extension 580 to fix part 574 to the first object. In some embodiments, extension 580 includes an opening 583 configured for disposal of screw 581.

Extension 578 includes a passageway that extends through a thickness of extension 578 to pivotally connect part 574 with part 582, as discussed herein. Extension 578 extends transverse to extension 580. In some embodiments, extension 578 extends perpendicular to extension 580. In some embodiments, extension 578 may be disposed at alternate orientations, relative to extension 580, such as, for example, other angular orientations such as acute or obtuse, co-axial and/or may be offset or staggered.

Part 582 includes an extension 584 and spaced apart flanges 586, 588 that extend from extension 584. Flanges 586, 588 each include an opening 590 that extends through a thickness of each of flanges 586, 588. Extension 578 of part 574 is positioned between flanges 586, 588 such that openings 590 are aligned with the passageway in extension 578. A pin 592 is positioned through openings 590 and the passageway in extension 578 to allow part 574 to pivot relative to part 582 about pin 592. In some embodiments, extension 584 has a configuration that mates with an inner surface that defines the cavity in a second object. In some embodiments, a fastener, such as, for example, a screw 585 is inserted through an outer surface of the second object and into extension 580 to fix part 576 to the second object. In some embodiments, extension 584 includes an opening 587 configured for disposal of screw 585.

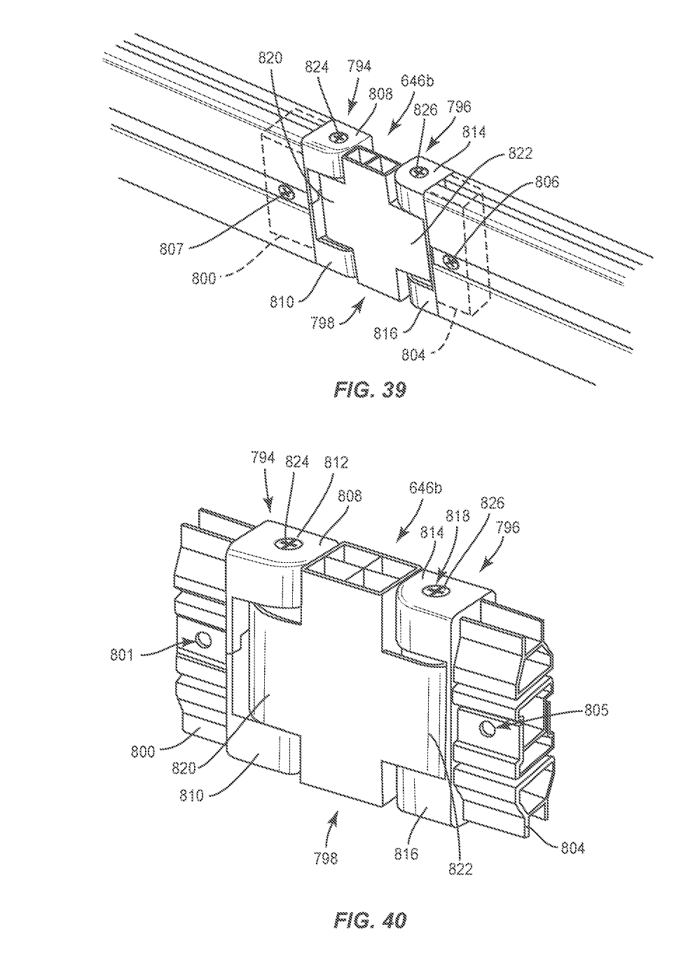

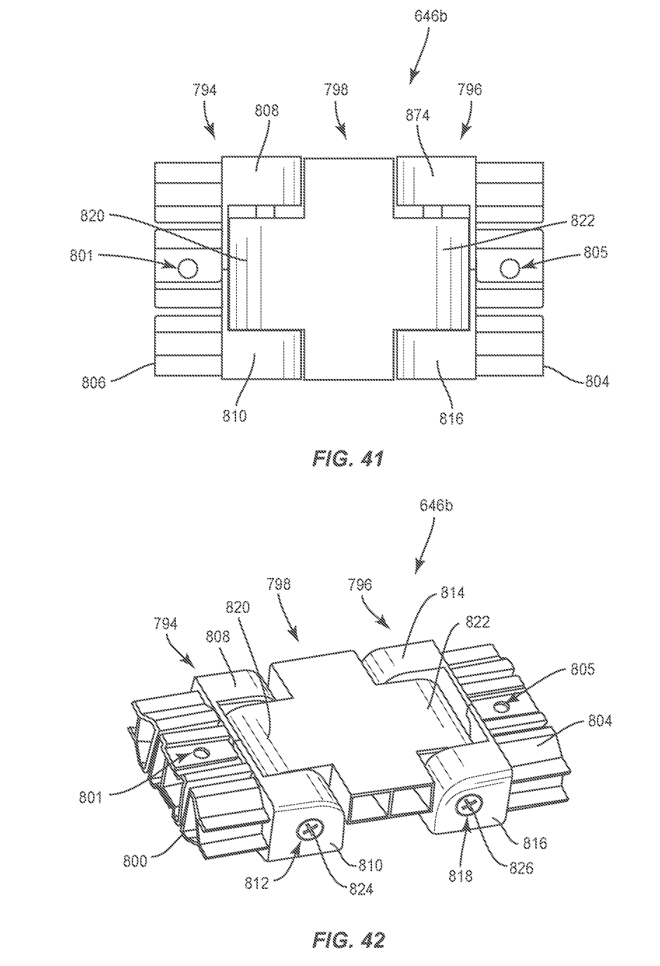

Turning to FIGS. 39-42, there are illustrated components of hinge 646b. Hinge 646b includes a part 794, a part 796 and a body 798 that is coupled to parts 794, 796 such that parts 794, 796 are pivotable relative to body 798. Part 794 includes an extension 800 configured for disposal in a cavity of a first object. In some embodiments, extension 800 has a configuration that mates with an inner surface that defines the cavity of the first object. In some embodiments, a fastener, such as, for example, a screw 802 is inserted through an outer surface of the first object and into extension 800 to fix part 774 to the first object. In some embodiments, extension 800 includes an opening 801 configured for disposal of screw 802.

Part 796 includes an extension 804 configured for disposal in a cavity of a second object. In some embodiments, extension 804 has a configuration that mates with an inner surface that defines the cavity of the second object. In some embodiments, a fastener, such as, for example, a screw 806 is inserted through an outer surface of the second object and into extension 800 to fix part 776 to the second object. In some embodiments, extension 804 includes an opening 805 configured for disposal of screw 806.

Part 794 includes spaced apart flanges 808, 810 that extend from extension 800. Flanges 808, 810 each include an opening 812 that extends through a thickness of flange 808 or flange 810. Part 796 includes spaced apart flanges 814, 816 that extend from extension 804. Flanges 814, 816 each include an opening 818 that extends through a thickness of flange 814 or flange 816. Flange 808 is aligned with flange 814 and flange 810 is aligned with flange 816.

Body 798 includes an arm 820 that extends from one side of body 798 and an arm 822 that extends from an opposite side of body 798. Arm 820 is positioned between flanges 808, 810 such that a passageway that extends through a thickness of arm 820 is aligned with openings 812. A pin 824 is inserted through openings 812 and the passageway of arm 800 to allow part 794 to pivot relative to body 798. Arm 822 is positioned between flanges 814, 816 such that a passageway that extends through a thickness of arm 822 is aligned with openings 818. A pin 826 is inserted through openings 818 and the passageway of arm 202 to allow part 796 to pivot relative to body 798.

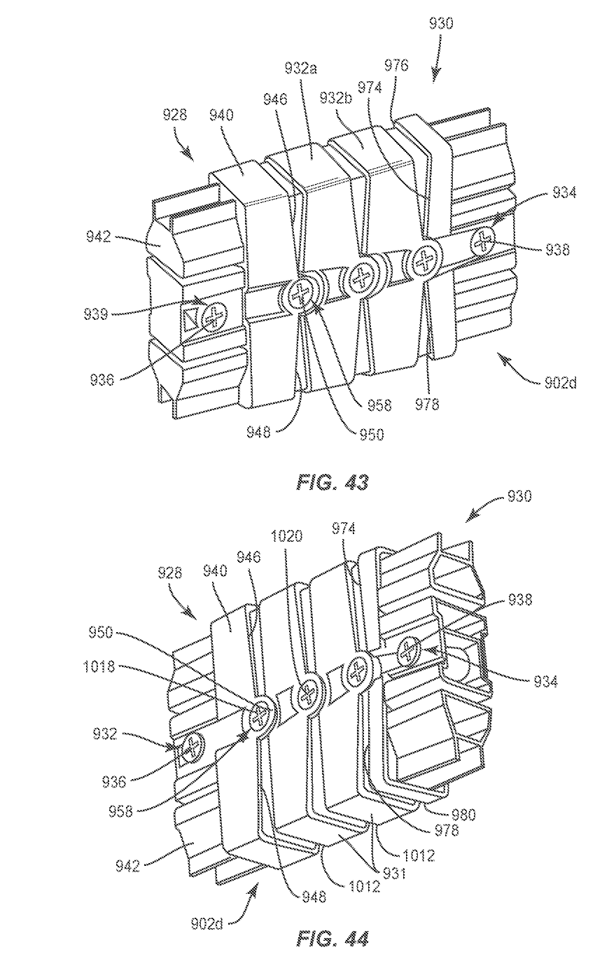

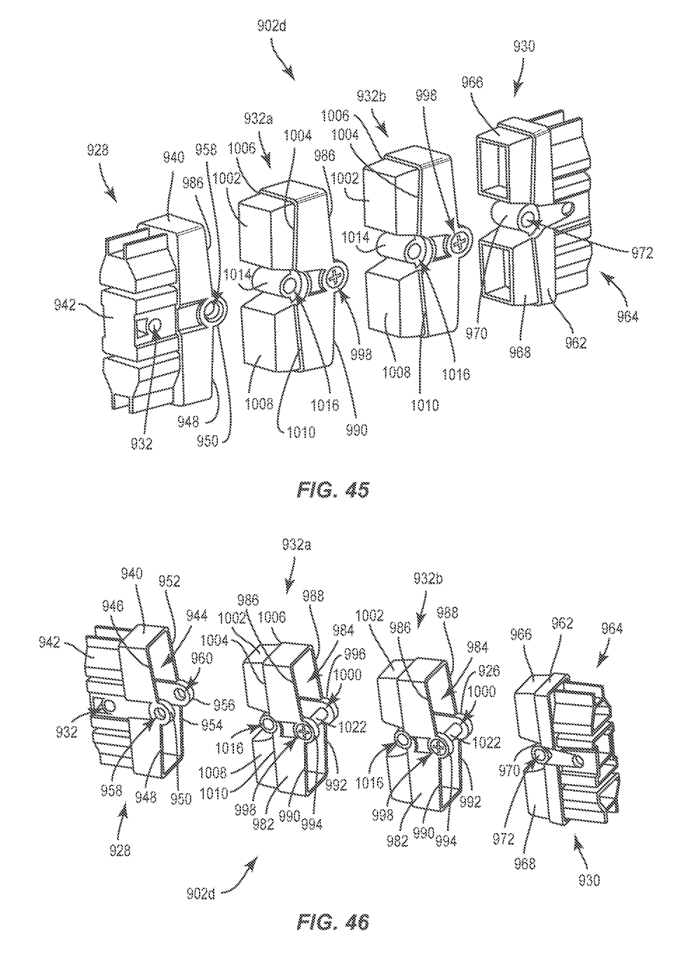

Turning to FIGS. 43-46, there are illustrated components of hinge 902d. Hinge 902d includes an end plate 928, an end plate 930 and one or more inner plates 932 between end plate 928 and end plate 930. End plate 928 is fixedly attached to a first object and end plate 930 is fixedly attached to a second object. In some embodiments, end plate 928 includes an opening 932 and end plate 930 includes an opening 934. A pin 936 extends through the first object and into opening 932 to fix end plate 928 to the first object and a pin 938 extends through the second object and into opening 934 to fix end plate 930 to the second object.

End plate 928 includes a body 940 and an extension 942 that extends from body 940. Opening 932 extends through extension 942. Extension 942 is configured for disposal in a cavity of the first object. In some embodiments, extension 942 has a configuration that mates with an inner surface that defines the cavity of the first object. Body 940 comprises an inner surface defining an aperture 944 configured for movable disposal of a portion of one of inner plates 932, as discussed herein. Body 940 includes inclined surfaces 946, 948 and a convex portion 950 between surfaces 946, 948. Body 940 includes inclined surfaces 952, 954 opposite inclined surfaces 946, 948 and a convex portion 956 between surfaces 952, 954. Convex portion 950 includes a hole 958 that is coaxial with a hole 960 of convex portion 956.

End plate 930 includes a body 962 and an extension 964 that extends from body 962. Opening 934 extends through extension 964. Extension 964 is configured for disposal in a cavity of a second object. In some embodiments, extension 964 has a configuration that mates with an inner surface that defines the cavity of the second object. Body 962 comprises a block 966, a block 968 and a cylindrical portion 970 between blocks 966, 968. Cylindrical portion 970 includes a passageway 972 that extends through a thickness of cylindrical portion 970. Block 966 extends from opposite inclined surfaces 974, 976 of body 962 and block 968 extends from opposite inclined surfaces 978, 980 of body 962. Cylindrical portion 970 is positioned between inclined surfaces 974, 976 and inclined surfaces 978, 980.

Inner plates 932 each include a body 982. An inner surface of body 982 defines an aperture 984 configured for disposal of a portion of another inner plate 932 or blocks 966, 968 of end plate 930, as discussed herein. Body 982 includes spaced apart inclined surfaces 986, 988 and spaced apart inclined surfaces 990, 992. A cylindrical portion 994 is positioned between inclined surfaces 986, 990 and a cylindrical portion 996 is positioned between inclined surfaces 988, 992. Portion 994 includes an opening 998 that extends through a thickness of portion 994 and portion 996 includes an opening 1000 that extends through a thickness of portion 996. Inner plates 932 each include a block 1002 that extends from spaced apart inclined surfaces 1004, 1006 of body 982 and a block 1008 that extends from spaced apart inclined surfaces 1010, 1012 of body 982. A cylindrical portion 1014 is positioned between block 1002 and block 1008. Cylindrical portion 1014 includes a passageway 1016 that extends through a thickness of cylindrical portion 1014.

Blocks 1002, 1008 of a first inner plate 932a are positioned within aperture 944 of end plate 928 such that passageway 1016 is aligned and/or coaxial with openings 958, 960 of first inner plate 932a. A pin 1018 is positioned through openings 958, 960 and passageway 1016 to allow first inner plate 932a to pivot relative to end plate 928 about pin 1018. First inner plate 932a is pivotable relative to end plate 928 between a first orientation, a second orientation and a third orientation. In the first orientation, inclined surfaces 1004, 1006 of first inner plate 932a directly engage inclined surfaces 946, 952 of end plate 928 and inclined surfaces 1010, 1012 of first inner plate 932a are spaced apart from inclined surfaces 948, 954 of end plate 928. In the second orientation, inclined surfaces 1004, 1006 of first inner plate 932a are spaced apart from inclined surfaces 946, 952 of end plate 928 and inclined surfaces 1010, 1012 of first inner plate 932a are spaced apart from inclined surfaces 948, 954 of end plate 928. In the third orientation, inclined surfaces 1004, 1006 of first inner plate 932a are spaced apart from inclined surfaces 946, 952 of end plate 928 and inclined surfaces 1010, 1012 of first inner plate 932a directly engage inclined surfaces 948, 954 of end plate 928. Inclined surfaces 946, 948, 952, 954, 1004, 1006, 1008, 1010 thus define stops that limit the amount first inner plate 932a pivots relative to end plate 928.

Blocks 1002, 1008 of a second inner plate 232b are positioned within aperture 984 of first inner plate 932a such that passageway 1016 of second inner plate 932b is aligned and/or coaxial with openings 998, 1000 of first inner plate 932a. A pin 1020 is positioned through openings 998, 1000 of first inner plate 932a and passageway 1016 of second inner plate 932b to allow first inner plate 932a to pivot relative to second inner plate 932b about pin 1020. First inner plate 932a is pivotable relative to second inner plate 932b between a first orientation, a second orientation and a third orientation. In the first orientation, inclined surfaces 986, 988 of first inner plate 932a directly engage inclined surfaces 1002, 1004 of second inner plate 932b and inclined surfaces 1010, 1012 of first inner plate 932 are spaced apart from inclined surfaces 990, 992 of second inner plate 932b. In the second orientation, inclined surfaces 986, 988 of first inner plate 932a are spaced apart from inclined surfaces 1002, 1004 of second inner plate 932b and inclined surfaces 1010, 1012 of first inner plate 932 are spaced apart from inclined surfaces 990, 992 of second inner plate 932b. In the third orientation, inclined surfaces 986, 988 of first inner plate 932a are spaced apart from inclined surfaces 1002, 1004 of second inner plate 932b and inclined surfaces 1010, 1012 of first inner plate 932 directly engage inclined surfaces 990, 992 of second inner plate 932b. Inclined surfaces 986, 988, 990, 992, 1004, 1006, 1008, 1010 thus define stops that limit the amount first inner plate 932a pivots relative to second inner plate 932b.

Blocks 966, 968 of end plate 930 are positioned within aperture 984 of second inner plate 932b such that passageway 972 of end plate 930 is aligned and/or coaxial with openings 998, 1000 of second inner plate 932b. A pin 1022 is inserted through passageway 972 of end plate 930 and openings 998, 1000 of second inner plate 932b such that of second inner plate 932b is pivotable relative to end plate 930 about pin 1022. Second inner plate 932b is pivotable relative to end plate between a first orientation, a second orientation and a third orientation. In the first orientation, inclined surfaces 986, 988 of second inner plate 932b directly engage inclined surfaces 974, 976 of end plate 930 and inclined surfaces 1010, 1012 of second inner plate 932b are spaced apart from inclined surfaces 978, 980 of end plate 928. In the second orientation, inclined surfaces 986, 988 of second inner plate 932b are spaced apart from inclined surfaces 974, 976 of end plate 930 and inclined surfaces 1010, 1012 of second inner plate 932b are spaced apart from inclined surfaces 978, 980 of end plate 928. In the third orientation, inclined surfaces 986, 988 of second inner plate 932b are spaced apart from inclined surfaces 974, 976 of end plate 930 and inclined surfaces 1010, 1012 of second inner plate 932b directly engage inclined surfaces 978, 980 of end plate 928. Inclined surfaces 986, 988, 990, 990 of second inner plate 932b and inclined surfaces 974, 976, 978, 980 of end plate 930 thus define stops that limit the amount second inner plate 932b pivots relative to end plate 930.

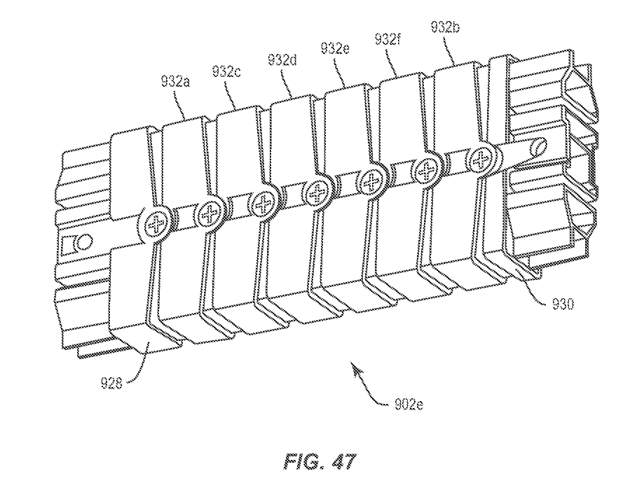

Turning to FIG. 47, there are illustrated components of hinge 902e. Hinge 902e includes inner plates 932c, 932d, 932e, 932f between inner plate 932a and inner plate 932b, as shown in FIG. 46. Inner plate 932c of hinge 902e is connected inner plate 932a of hinge 902e in the same manner as inner plate 932a of hinge 902d is connected to inner plate 932b of hinge 902d. Inner plate 932d of hinge 902e is connected inner plate 932c of hinge 902e in the same manner as inner plate 932a of hinge 902d is connected to inner plate 932b of hinge 902d. Inner plate 932e of hinge 902e is connected inner plate 932d of hinge 902e in the same manner as inner plate 932a of hinge 902d is connected to inner plate 932b of hinge 902d. Inner plate 932f of hinge 902e is connected inner plate 932b of hinge 902e in the same manner as inner plate 932a of hinge 902d is connected to inner plate 932b of hinge 902d. It is envisioned that hinge 902e may include one or a plurality of inner plates 932 between end plate 928 and end plate 930.

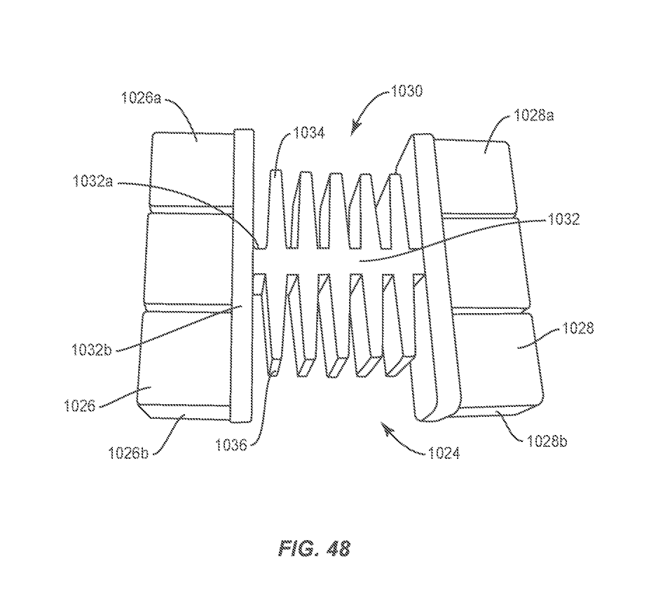

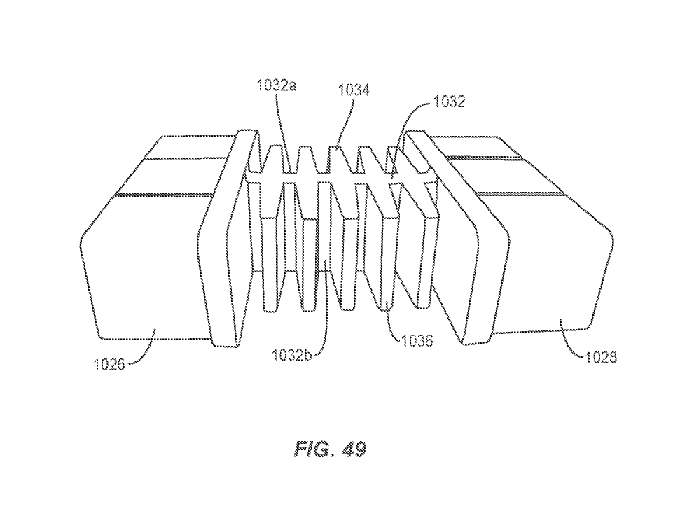

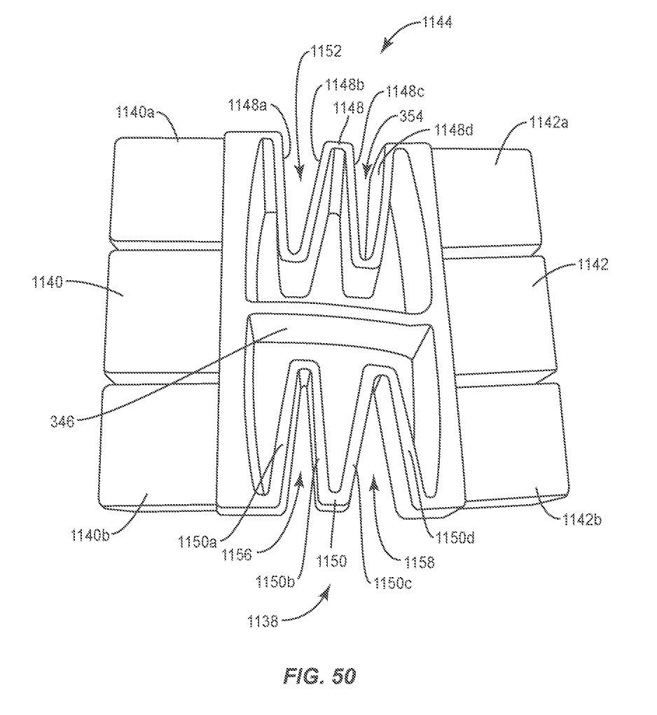

Turning to FIGS. 48-49, there are illustrated components of hinge 1034. Hinge 1024 includes an extension 1026, an extension 1028 and a central portion 1030 between extensions 1026, 1028. Extension 1026 is configured for disposal in a first object and extension 1028 is configured for disposal in a second object. In some embodiments, extensions 1026, 1028 are configured for disposal in the first object or the second object such that extensions 1026, 1028 are fixed relative to the first object or the second object. In some embodiments, extensions 1026, 1028 are deformable such that extensions 1026, 1028 are fixed relative to the first object or the second object when extensions 1026, 1028 are disposed in the first object or the second object.

Central portion 1030 includes a rib 1032 that connects extension 1026 with extension 1028. Extensions 1026, 1028 are each deflectable relative to rib 1032 to allow extension 1026 to pivot relative to extension 1028. Central portion 1030 includes a plurality of spaced apart fins 1034 that extend from a first side 1032a of rib 1032 and a plurality of spaced apart fins 1036 that extend from a second side 1032b of rib 1032. As shown in FIGS. 47 and 48, each one of fins 1034 is aligned with one of fins 1036. Fins 1034 are configured to directly engage extension 1026, extension 1028 or another one of fins 1034 to limit the amount that extension 1026 can pivot relative to extension 1028. Likewise, fins 1036 are configured to directly engage extension 1026, extension 1028 or another one of fins 1036 to limit the amount that extension 1026 can pivot relative to extension 1028. For example, extension 1026 may be pivoted relative to extension 1028 such that first ends 1026a, 1028a of extensions 1026, 1028 are moved toward one another and opposite second ends 1026b, 1028b of extensions 1026, 1028 are moved away from one another. As first ends 1026a, 1028a of extensions 1026, 1028 are moved toward one another, the space between adjacent fins 1036 increases and fins 1034 engage another one of fins 1034 and/or one of extensions 1026, 1028 to limit the amount that extension 1026 pivots relative to extension 1028. Extension 1026 may be also pivoted relative to extension 1028 such that first ends 1026a, 1028a of extensions 1026, 1028 are moved away from one another and second ends 1026b, 1028b of extensions 1026, 1028 are moved toward one another. As second ends 1026b, 1028b of extensions 1026, 1028 are moved toward one another, the space between adjacent fins 1034 increases and fins 1036 engage another one of fins 1036 and/or one of extensions 1026, 1028 to limit the amount that extension 1026 pivots relative to extension 1028.

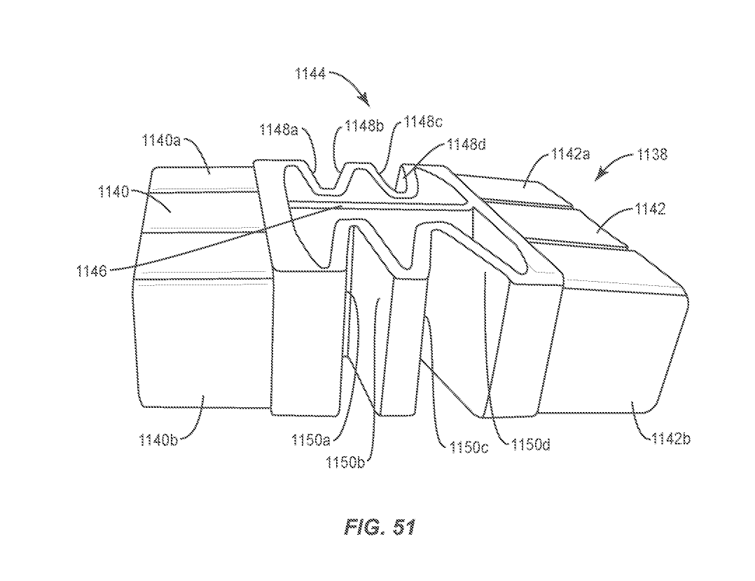

Turning to FIGS. 50-51, there are illustrated components of hinge 1138. Hinge 1138 includes an extension 1140, an extension 1142 and a central portion 1144 between extensions 1140, 1142. Extension 1140 is configured for disposal in a first object and extension 1142 is configured for disposal in a second object. In some embodiments, extensions 1140, 1142 are configured for disposal in the first object or the second object such that extensions 1140, 1142 are fixed relative to the first object or the second object. In some embodiments, extensions 1140, 1142 are deformable such that extensions 1140, 1142 are fixed relative to the first object or the second object when extensions 1140, 1142 are disposed in the first object or the second object.

Central portion 1144 includes a rib 1146 that connects extension 1140 with extension 1142. Extensions 1140, 1142 are each deflectable relative to rib 1146 to allow extension 1140 to pivot relative to extension 1142. Central portion 1144 includes a wall 1148 that connects a first end 1140a of extension 1140 with a first end 1142a of extension 1142 and a wall 1150 that connects a second end 1140b of extension 1140 with a second end 1142b of extension 1142. Rib 1146 is spaced apart from walls 1148, 1150. Wall 1148 includes a section 1148a that is connected to a section 1148b of wall 1148 to define a concave portion 1152 of wall 1148. Section 1148a extends transverse to section 1148b. Wall 1148 includes a section 1148c that is connected to a section 1148d of wall 1148 to define a concave portion 1154 of wall 1148. Section 1148c extends transverse to section 1148d. Section 1148a is connected to extension 1140 by a portion of wall 1148 that extends transverse to sections 1148b, 1148c. Section 1148a is connected to section 1148b by a portion of wall 1148 that extends transverse to sections 1148a, 1148b. Section 1148c is connected to section 1148b by a portion of wall 1148 that extends transverse to sections 1148b, 1148c. Section 1148c is connected to section 1148d by a portion of wall 1148 that extends transverse to sections 1148c, 1148d. Section 1148d is connected to extension 1142 by a portion of wall 1148 that extends transverse to sections 1148b, 1148c.

Wall 1150 includes a section 1150a that is connected to a section 1150b of wall 1150 to define a concave portion 1156 of wall 1150. Section 1150a extends transverse to section 1150b. Wall 1150 includes a section 1150c that is connected to a section 1150d of wall 1150 to define a concave portion 1158 of wall 1148. Section 1150c extends transverse to section 1150d. Section 1150a is connected to extension 1140 by a portion of wall 1150 that extends transverse to sections 1150b, 1150c. Section 1150a is connected to section 1150b by a portion of wall 1150 that extends transverse to sections 1150a, 1150b. Section 1150c is connected to section 1150b by a portion of wall 1150 that extends transverse to sections 1150b, 1150c. Section 1150c is connected to section 1150d by a portion of wall 1150 that extends transverse to sections 1150c, 1150d. Section 1150d is connected to extension 1142 by a portion of wall 1150 that extends transverse to sections 1150b, 1150c.

Sections 1148a, 1148d are configured to directly engage extension 1140, extension 1142 or one of sections 1148b, 1148c to limit the amount that extension 1140 can pivot relative to extension 1142. Likewise, sections 1150a, 1150d are configured to directly engage extension 1140, extension 1142 or one of sections 1150b, 1150c to limit the amount that extension 1140 can pivot relative to extension 1142. For example, extension 1140 may be pivoted relative to extension 1142 such that first ends 1140a, 1142a of extensions 1140, 1142 are moved toward one another and opposite second ends 1140b, 1142b of extensions 1140, 1142 are moved away from one another. As first ends 1140a, 1142a of extensions 1140, 1142 are moved toward one another, the space between extension 1140 and section 1148a, between section 1148a and section 1148b, between section 1148b and section 1148c, between section 1148c and section 1148d, and/or between section 1148d and extension 1142 decreases and the space between extension 1140 and section 1150a, between section 1150a and section 1150b, between section 1150b and section 1150c, between section 1150c and section 1150d, and/or between section 1150d and extension 1142 increases to limit the amount that extension 1140 pivots relative to extension 1142. Extension 1140 may be also pivoted relative to extension 1142 such that first ends 1140a, 1142a of extensions 1140, 1142 are moved away from one another and second ends 1140b, 1142b of extensions 1140, 1142 are moved toward one another. As second ends 1140b, 1142b of extensions 1140, 1142 are moved toward one another, the space between extension 1140 and section 1148a, between section 1148a and section 1148b, between section 1148b and section 1148c, between section 1148c and section 1148d, and/or between section 1148d and extension 1142 increases and the space between extension 1140 and section 1150a, between section 1150a and section 1150b, between section 1150b and section 1150c, between section 1150c and section 1150d, and/or between section 1150d and extension 1142 decreases to limit the amount that extension 1140 pivots relative to extension 1142.

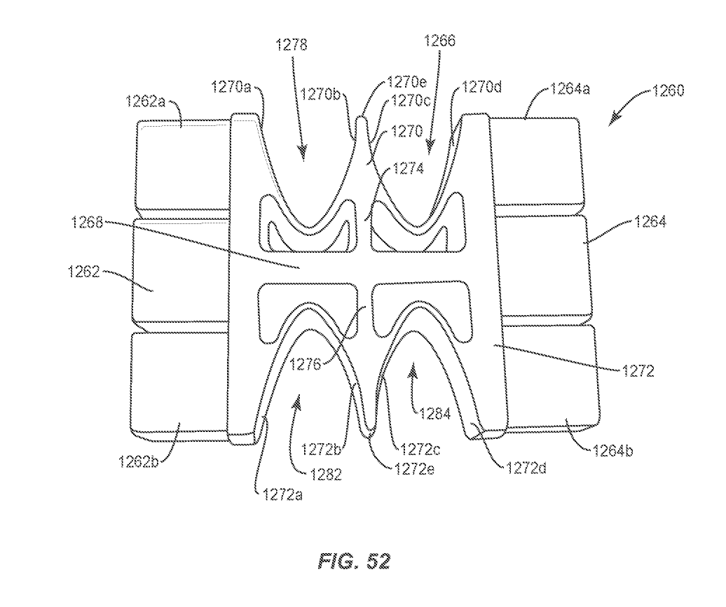

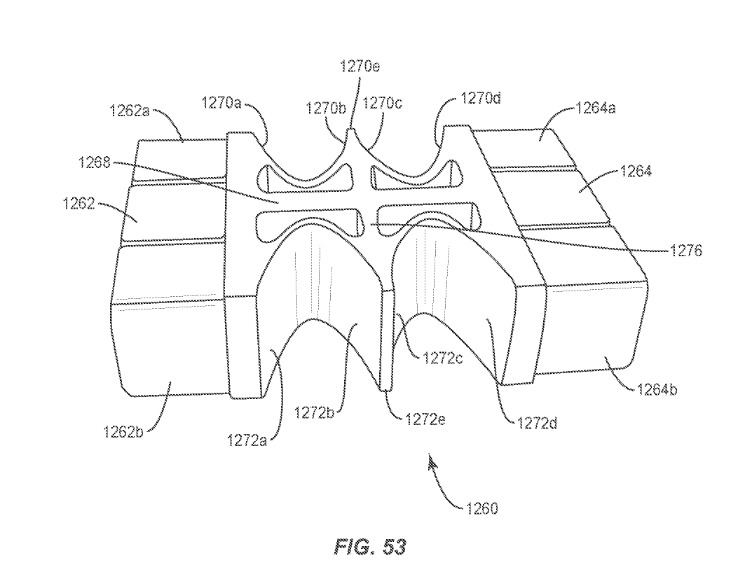

Turning to FIGS. 52-53, there are illustrated components of hinge 1260. Hinge 1260 includes an extension 1262, and extension 1264 and a central portion 1266 between extensions 1262, 1264. Extension 1262 is configured for disposal in a first object and extension 1264 is configured for disposal in a second object. In some embodiments, extensions 1262, 1264 are configured for disposal in the first object or the second object such that extensions 1262, 1264 are fixed relative to the first object or the second object. In some embodiments, extensions 1262, 1264 are deformable such that extensions 1262, 1264 are fixed relative to the first object or the second object when extensions 1262, 1264 are disposed in the first object or the second object.

Central portion 1266 includes a rib 1268 that connects extension 1262 with extension 1264. Extensions 1262, 1264 are each deflectable relative to rib 1268 to allow extension 1262 to pivot relative to extension 1264. Central portion 1266 includes a wall 1270 that connects a first end 1262a of extension 1262 with a first end 1264a of extension 1264 and a wall 1272 that connects a second end 1262b of extension 1262 with a second end 1264b of extension 1264. Rib 1268 is connected to wall 1270 by an arm 1274 and rib 1268 is connected to wall 1272 by an arm 1276 that is aligned and/or coaxial with arm 1274. Arms 1274, 1276 extend transverse to rib 1268. In some embodiments, arms 1274, 1276 extend perpendicular to rib 1268. Wall 1270 includes an arcuate section 1270a that is connected to an arcuate section 1270b of wall 1270 to define a concave portion 1278 of wall 1270. Wall 1270 includes an arcuate section 1270c that is connected to an arcuate section 1270d of wall 1270 to define a concave portion 1280 of wall 1270. Section 1270b is connected to section 1270c by a portion 1270e of wall 1270 that extends parallel to rib 1268. Section 1270a is continuously curved from extension 1262 to section 1270b. Section 1270b is continuously curved from section 1270b to portion 1270e. Section 1270c is continuously curved from portion 1270e to section 1270d. Section 1270d is continuously curved from portion 1270c to extension 1264. Wall 1270 is thus continuously curved from extension 1262 to portion 1270e and from portion 1270e to extension 1264. Wall 1272 includes an arcuate section 1272a that is connected to an arcuate section 1272b of wall 1272 to define a concave portion 1282 of wall 1272. Wall 1272 includes an arcuate section 1272c that is connected to an arcuate section 1272d of wall 1272 to define a concave portion 1284 of wall 1272. Section 1272b is connected to section 1272c by a portion 1272e of wall 1270 that extends parallel to rib 1268. Section 1272a is continuously curved from extension 1262 to section 1272b. Section 1272b is continuously curved from section 1272b to portion 1272e. Section 1272c is continuously curved from portion 1270e to section 1272d. Section 1272d is continuously curved from portion 1272c to extension 1264. Wall 1272 is thus continuously curved from extension 1262 to portion 1272e and from portion 1272e to extension 1264.

Extensions 1262, 1264 are configured to directly engage a section of wall adjunct to portion 1270e to limit the amount that extensions 1262, 1264 can pivot relative to one another. Likewise, extensions 1262, 1264 are configured to directly engage a section of wall adjunct to portion 1272e to limit the amount that extensions 1262, 1264 can pivot relative to one another. For example, extension 1262 may be pivoted relative to extension 1264 such that first ends 1262a, 1264a of extensions 1262, 1264 are moved toward one another and opposite second ends 1262b, 1264b of extensions 1262, 1264 are moved away from one another. As first ends 1262a, 1262a of extensions 1262, 1264 are moved toward one another, sections 1270a, 1270d of wall 1270 move toward portion 1270e of wall 1270 and sections 1272a, 1272d of wall 1272 move away from portion 1272 of wall 1272. In some embodiments, a junction between sections 1270a, 1270b of wall 1270 moves toward rib 1268 as first ends 1262a, 1262a of extensions 1262, 1264 are moved toward one another. In some embodiments, a junction between sections 1270c, 1270d of wall 1270 moves toward rib 1268 as first ends 1262a, 1262a of extensions 1262, 1264 are moved toward one another. In some embodiments, a junction between sections 1272a, 1272b of wall 1272 moves away rib 1268 as first ends 1264a, 1264a of extensions 1262, 1264 are moved toward one another. In some embodiments, a junction between sections 1272c, 1272d of wall 1272 moves away from rib 1268 as first ends 1264a, 1264a of extensions 1262, 1264 are moved toward one another.

Extension 1262 may be also pivoted relative to extension 1264 such that first ends 1262a, 1264a of extensions 1262, 1264 are moved away from one another and second ends 1262b, 1264b of extensions 1262, 1264 are moved toward one another. As second ends 1262b, 1264b of extensions 1262, 1264 are moved toward one another, sections 1270a, 1270d of wall 1270 move away from portion 1270e of wall 1270 and sections 1272a, 1272d of wall 1272 move toward portion 1272 of wall 1272. In some embodiments, the junction between sections 1272a, 1272b of wall 1272 moves toward rib 1268 as second ends 1264b, 1264b of extensions 1262, 1264 are moved toward one another. In some embodiments, the junction between sections 1272c, 1272d of wall 1272 moves toward rib 1268 as second ends 1264b, 1264b of extensions 1262, 1264 are moved toward one another. In some embodiments, the junction between sections 1270a, 1270b of wall 1270 moves away rib 1268 as second ends 1264b, 1264b of extensions 1262, 1264 are moved toward one another. In some embodiments, the junction between sections 1270c, 1270d of wall 1270 moves away from rib 1268 as second ends 1264b, 1264b of extensions 1262, 1264 are moved toward one another.

It will be understood that various modifications may be made to the embodiments disclosed herein. For example, features of any one embodiment can be combined with features of any other embodiment. Therefore, the above description should not be construed as limiting, but merely as exemplification of the various embodiments. Those skilled in the art will envision other modifications within the scope and spirit of the claims appended hereto.

What is claimed is:

1. A hinge comprising:
a first end plate;
a second end plate; and
at least one inner plate positioned between the first end plate and the second end plate, the first end plate being connected to the at least one inner plate by a first pin that extends through the first end plate and the at least one inner plate, the second end plate being connected to the at least one inner plate by a second pin that extends through the first end plate and the at least one inner plate,
wherein the first end plate is rotatable relative to the at least one inner plate about a first pivot axis defined by the first pin and the second end plate is rotatable relative to the at least one inner plate about a second pivot axis defined by the second pin.

2. A hinge as recited in claim 1, wherein the hinge has a length that extends along a longitudinal axis from the first end plate to the second end plate, the pivot axes each extending transverse to the longitudinal axis.

3. A hinge as recited in claim 1, wherein the hinge has a length that extends along a longitudinal axis from the first end plate to the second end plate, the pivot axes each extending perpendicular to the longitudinal axis.

4. A hinge as recited in claim 1, wherein the at least one inner plate comprises a plurality of inner plates that are pivotable relative to one another.

5. A hinge as recited in claim 4, wherein a first inner plate of the plurality of inner plates is connected to the first end plate, a second inner plate of the plurality of inner plates is connected to the second end plate and a third inner plate of the plurality of inner plates is connected to the first and second inner plates.

6. A hinge as recited in claim 5, wherein the hinge comprises a third pin that extends through the first and third inner plates and a fourth pin that extends through the second and third inner plates.

7. A hinge as recited in claim 6, wherein the third inner plate is rotatable relative to the first inner plate about a third pivot axis defined by the third pin and the third inner plate is rotatable relative to the second inner plate about a fourth pivot axis defined by the fourth pin.

8. A hinge as recited in claim 7, wherein the hinge has a length that extends along a longitudinal axis from the first end plate to the second end plate, the pivot axes each extending perpendicular to the longitudinal axis.

9. A hinge as recited in claim 5, wherein the first inner plate comprises a pair of blocks that translate within a cavity of the third inner plate as the third inner plate pivots relative to the first inner plate.

10. A hinge as recited in claim 1, wherein the at least one inner plate comprises a convex extension that engages a concave recess in the first end plate, the extension rotating within the recess as the first end plate rotates relative to the at least one inner plate.

11. A hinge as recited in claim 1, wherein the at least one inner plate comprises a convex extension having an aperture and the first end plate comprises a cylindrical portion having a passageway, the first pin extending through the aperture and the passageway.

12. A hinge as recited in claim 1, wherein the at second end plate comprises a convex extension that engages a concave recess in the at least one inner plate, the extension rotating within the recess as the second end plate rotates relative to the at least one inner plate.

13. A hinge as recited in claim 1, wherein the second end plate comprises a convex extension having an aperture and the at least one inner plate comprises a cylindrical portion having a passageway, the second pin extending through the aperture and the passageway.

14. A hinge as recited in claim 1, wherein the first end plate comprises a pair of blocks that translate within a cavity of the at least one inner plate as the at least one inner plate pivots relative to the first end plate.

15. A hinge as recited in claim 1, wherein the at least one inner plate comprises a pair of blocks that translate within a cavity of the second end plate as the at least one inner plate pivots relative to the second end plate.

16. A hinge as recited in claim 1, wherein the first end plate is structurally distinct from the second end plate.

17. A bedding system comprising:
a frame comprising top and bottom rails that are connected by spaced apart side rails, the side rails each comprising a first portion and a second portion that is connected to the first portion by a hinge, the hinge comprising:
a first end plate,
a second end plate, and
at least one inner plate positioned between the first end plate and the second end plate, the first end plate being connected to the at least one inner plate by a first pin that extends through the first end plate and the at least one inner plate, the second end plate being connected to the at least one inner plate by a second pin that extends through the first end plate and the at least one inner plate,
wherein the first end plate is rotatable relative to the at least one inner plate about a first pivot axis defined by the first pin and the second end plate is rotatable relative to the at least one inner plate about a second pivot axis defined by the second pin.

18. A bedding system as recited in claim 17, wherein the first end plates each comprising at least one extension that is positioned within a cavity of one of the first portions and the second end plate each comprising at least one extension that is positioned within a cavity of one of the second portions.

19. A bedding system as recited in claim 17, further comprising a mattress positioned on top of the frame.

20. A hinge comprising:
a first end plate;
a second end plate, the first end plate being structurally distinct from the second end plate; and
a plurality of inner plates positioned between the first end plate and the second end plate, the first end plate being connected to a first one of the inner plates by a first pin that extends through the first end plate and the first one of the inner plates, the second end plate being connected to a second one of the inner plates by a second pin that extends through the second end plate and the second one of the inner plates, a third one of the inner plates being connected to a fourth one of the inner plates by a third pin that extends through the third one of the inner plates and the fourth one of the inner plates,
wherein the first end plate is rotatable relative to the first one of the inner plates about a first pivot axis defined by the first pin, the second end plate is rotatable relative to the second one of the inner plates about a second pivot axis defined by the second pin and the third one of the inner plates is rotatable relative to the fourth one of the inner plates about a third pivot axis defined by the third pin, and
wherein the hinge has a length that extends along a longitudinal axis from the first end plate to the second end plate, the pivot axes each extending perpendicular to the longitudinal axis.
